(19) United States
(12) Patent Application Publication
(10) Pub. No.: US 2017/0045427 A1
(43) Pub. Date: Feb. 16, 2017

(54) METHOD FOR GUIDING CELL SPREADING IN AUTOMATED CYTOGENETIC ASSAYS

(71) Applicant: The Arizona Board of Regents On Behalf Of The University of Arizona, Tucson, AZ (US)

(72) Inventors: Frederic ZENHAUSERN, Fountain Hills, AZ (US); Jian GU, Chandler, AZ (US)

(73) Assignee: The Arizona Board of Regents On Behalf Of The University of Arizona, Tucson, AZ (US)

(21) Appl. No.: 15/119,098

(22) PCT Filed: Feb. 20, 2015
(86) PCT No.: PCT/US15/16919

§ 371 Date: Aug. 15, 2016

Related U.S. Application Data
(60) Provisional application No. 61/942,465, filed on Feb. 20, 2014.

(51) Int. Cl. G01N 1/28; G01N 21/84; G01B 11/06; G06T 3/40; G01N 15/14; H04N 5/225; H04N 5/76; G01B 11/10; G01B 11/24

(52) U.S. Cl. CPC G01N 1/2813; G01B 11/105; G01N 21/84; G01B 11/0616; G01B 11/2441; G01N 15/1475; H04N 5/2256; H04N 5/76; G06T 3/4076; G01N 2015/1006

(57) ABSTRACT

Provided herein are methods and related systems for controlling droplet spreading on a surface, including droplets in which a biological component is suspended. A biological solution is provided as a droplet to a surface. Interference fringes generated by the droplet on the surface are imaged, wherein the imaging is over a time course during which the droplet spreads on the surface. A droplet parameter is determined from the imaging step and a process parameter controlled to obtain an interference fringe pattern corresponding to a desired droplet parameter. In this manner, well-controlled droplet spreading is achieved, which is important in a range of applications, including assays that rely on good metaphase spreading.

### CROSS-REFERENCE TO RELATED APPLICATIONS

This application claims the benefit of priority from U.S. Provisional Patent Application No. 61/942,465 filed Feb. 20, 2014, which is hereby incorporated by reference in its entirety to the extent not inconsistent herewith.

### BACKGROUND OF INVENTION

Generally provided are systems and methods for providing robust and reliable fluid droplet spreading characterization and control. The ability to understand and control droplet spreading has a number of important applications. For example, chromosome metaphase spread is an important application used in both research and clinical laboratories. This metaphase spread involves dropping a spreading solution containing target cells onto a substrate and allowing the solution to spread out and evaporate. Despite the apparent simplicity in the procedure, achieving high quality chromosome spread is an uncertain process, with varying results between laboratories, individuals, as well as experimental variation. This fundamentally limits the full potential of cytogenetic techniques, including hindering automation of the process for rapid and reliable high-throughput handling.

Although automation of image analysis of chromosomes and other cellular components has been attempted, the sample preparing step is a limiting empirical and labor-intensive step. Dynamics of methanol and acetic acid fixative sessile drop is important for metaphase chromosomal spreads in cytogenetic assays. There are also other types of solvent mixtures to facilitate and speed the process, but the underlying mechanisms are not fully understood and characterized from a physical science perspective, including for incorporation of the procedure into automated processing applications. The systems and methods provided herein overcome certain limitations by providing droplet spreading having parameters that can be adjusted, manipulated, controlled and analyzed, in a manner suitable for automated droplet spreading systems.

Many factors affect chromosome spreading, including by affecting the dynamics of the sessile fixative drop spreading and evaporation. Such dynamic process, however, is only speculated in the biological context, and has not been characterized using physical science techniques and at a scale relevant to the cell and chromosome spreading dimensions. Provided herein are methods and systems for implementing the methods that use optical imaging and interference fringe analysis in a dynamic manner, to facilitate interrogation of the effects of fixative fluid local environment on chromosome spreading at the cellular scale, such as at 1 μm or better resolution.

### SUMMARY OF THE INVENTION

The ability to characterize fluid behavior at small scales, particularly at a scale comparable to cell size is important for understanding of metaphase spreading process at micro- and nano-scale. In order to provide reliable quality, high-fidelity and high-throughput metaphase spreading, the droplet dynamics must be well-understood. With a well-defined droplet dynamic that provides good quality metaphase spreading, process parameters may be controlled so as to ensure the desired spreading condition is achieved. The systems and methods provided herein address this problem, including in a manner that is amenable for incorporation with high-throughput, robust and automatable processes by imaging interference fringes generated by spreading fluid droplets on a substrate, such as an optically transparent substrate.

In an aspect, provided herein is a method of controlling droplet spreading on a surface by suspending a biological component in a spreading solution to form a biological solution. A droplet of the biological solution is provided on a surface, such as an optically transparent surface. Interference fringes generated by the droplet on the surface are imaged, wherein the imaging is over a time course during which the droplet spreads on the surface. Optionally, the imaging step may further comprise phase contrast microscopy, such as to image the biological component. The imaging step may be by video microscopy, including color imaging, that images the interference images. The interference fringes from the imaging step may be used to determine a droplet parameter which, in turn, is used to control a process parameter to obtain an interference fringe pattern corresponding to a desired droplet parameter. In this manner, the assessment may be referred to as iterative or having feedback control, where a process parameter, such as heat, humidity, sample or fluid composition, is adjusted to provide a desired interference fringe pattern that reflects a desired droplet parameter. Alternatively, an empirical model or calibration-type process is developed so that, for a given experimental condition, the desired process parameters are known and implemented accordingly during the spreading process, so as to achieve a desired droplet spreading. In this manner, droplet spreading on a surface is controlled, so as to ensure the desired droplet spreading characteristic is achieved. The methods provided herein may incorporate both aspects, such as use of initial starting conditions obtained from a method of the instant invention in combination with active feedback control during the droplet spreading. In this manner, desired droplet parameter(s) can be obtained throughout the spreading process dependent on the desired end application.

In an aspect, the biological component is a whole cell, such as a whole cell from a patient, including a tissue sample, biopsy, or the like wherein a diagnosis is desired. Alternatively, the biological component may be a cultured cell or other commercially-available cell-line that may be used for control or other experimental testing purposes. Alternatively, the biological component is a portion of a cell, such as the nucleus.

The droplet parameter may be one or more of: drop film thickness; droplet cross-sectional profile; droplet diameter; surface thinning speed; and droplet composition. Depending on the start conditions and desired outcome, there may be one or more desired droplet parameters, where matching of the desired droplet parameter ensures a positive end outcome related to a metaphase spread. For example, initial slow evaporation may correspond to a droplet parameter of slower change in drop film thickness, or diameter. For certain outcomes and droplet compositions, this may be desirable over the first portion of cell spreading, such as over the first 50% of cell spreading. Then, desirably, higher evaporation may be desired, such as faster change in droplet diameter and surface thinning speed, such as over the last 50%. In this manner, any combination of desired droplet parameters may be correspondingly generated from a variety of user-controlled process parameters. The systems and methods provided herein advantageously allow for such precise control of droplet parameters in a dynamic manner, such as by dynamic control, including feedback control, of process parameters, thereby ensuring quality control for the end application, such as metaphase spreading. Such quality control is of particular use in applications that are automated and high-throughput. For example, ideal droplet spreading for desired metaphase spreading is tailored to the droplet conditions, including specific cell type, concentration, and diagnosis application. If the ideal droplet spreading is not achieved, an error or alarm alert may be provided for active analysis and trouble shooting.

Examples of relevant process parameters are one or more of: humidity of the environment surrounding the droplet; droplet volume, droplet temperature; droplet evaporative dynamics, or time courses thereof. In an aspect, the one or more process parameters are varied over at least a portion of the time course to obtain a desired time course of interference fringes.

In an aspect, the method further comprises the step of adjusting humidity, temperature, or both humidity and temperature to provide water-induced swelling of said biological component, including a precisely defined and desirable water-induced swelling that is simply not achievable in conventional systems, particularly in a dynamic manner wherein the adjustment varies over time. Accordingly, any of the methods provided herein are for adjusting at a specific time interval during droplet spreading, including adjusting for different droplet parameters that change with time.

In an aspect, the adjusting controls a spreading composition time course, geometry time course, or both composition and geometry time course. “Geometry time course” refers to the relative location/position of the fluids in the droplet. For example, a first fluid may, at one time point, be enveloped by a second fluid, but at a second time point the second fluid envelopment thickness may change, or may even entirely evaporate, leaving behind only a first fluid.

In an aspect, the biological component comprises a cell and the adjusting step achieves optimum cell swelling for a metaphase analysis.

The imaging may comprise illuminating the droplet with a light source and observing an image of the droplet with a camera (e.g., video microscopy), and acquiring a time course video of droplet spreading with a computer from a plurality of observed images at different time points during droplet spreading. The interference fringes may have an optical resolution that is on a scale similar to a size of a biological cell or is better than 1 μm. The interference fringes generated by the drop spreading over time may be recorded.

The determining step may comprise counting an order of interference fringes; and fitting the counted order of interference fringes to a droplet profile or droplet thickness over time. The determining may be at selected times over the time course during which the droplet spreads on the surface, or may be at a selected droplet location over the time course during which the droplet spreads on the surface. The determining step may further comprise generating a droplet surface thinning speed versus time at a selected droplet location.

The droplet may comprise a plurality of biological cells positioned in an interior location of the droplet. For a two liquid spreading solution, initially, a first liquid may be covered by a second liquid, wherein the biological cells are immersed in the first liquid. In this manner, initial evaporative and humidity effects may be preferably located away from the biological cells, and constrained by the outer-positioned second fluid.

In an aspect, the biological cells have been exposed to a source of radiation; are from a biological sample containing potentially cancerous or pre-cancerous cells; are from a pre-natal biological sample; or are from a post-natal biological sample. The biological cells may be in metaphase.

The systems and methods provided herein are compatible with a range of spreading solutions. The methods are compatible with a range of spreading solutions, so long as the spreading solution provides for controlled dispersion over a substrate, and may include water, biologically-compatible fluids, such as PBS, or mixture of other fluids used in any application of interest. For example, the spreading solution may be a fixative solution. For example, the fixative solution fluid may comprise a single fluid or may comprise two distinct fluids. As desired, more than two distinct fluids may be used, to provide further process controllability, depending on the desired end application.

Examples of fixative solutions include one or more of: acetic acid; methanol; ethanol; mixtures thereof, such as a mixture of acetic acid and methanol. For example, the fluid droplet or fixative solution may be a biphasic mixture of a first fluid that is methanol and a second fluid that is acetic acid at a ratio of between 2.5:1 to 3:1. The biological component may be cells suspended in the methanol and the acetic acid envelopes the methanol.

The first fluid and the second fluid may have a different evaporation rate and water absorption property, thereby facilitating swelling of a biological cell in the droplet.

Any of the methods may further comprise controlling an evaporative parameter of the fluid droplet by one or more of: varying a ratio of the first fluid to the second fluid; varying humidity level; or varying temperature; to obtain an optimized swelling of the biological swells for a metaphase analysis application.

The droplet may be described in terms of an initial droplet volume when provided to the surface, the initial droplet volume selected from a range that is greater than or equal to 1 μL and less than or equal to 1 mL.

To ensure maximum process control, the droplet spreading is in a controllable and variable humidified environment.

The methods provided herein are useful in many kinds of applications, such as an application that is: a cytogenetic assay; a dicentric identification assay; a radiological exposure assay; a fluorescent in situ hybridization (FISH) assay; a multi-color FISH (M-FISH) assay; a spectral karyotyping assay; and a chromosome banding assay (G-, C-, Q-, R-banding).

Any of the methods may be used in a high-throughput dicentric chromosome assay to provide a high-quality chromosome metaphase spread.

The high-quality chromosome metaphase spread may be characterized by one or more of: metaphase area, chromosome lengths, number of broken cells, number of chromosome overlaps.

The method may further comprise controlling a temperature of the droplet; or controlling relative humidity in an environment surrounding the droplet; thereby affecting a fluid droplet composition corresponding to water content level or a percentage of a first fluid to a second fluid that forms the fixative solution. This may be performed in a temporally dynamic manner.

The controlling relative humidity may be by providing a controllable external moisture flux source. The controlling the temperature of the droplet may be by controlling a temperature on the surface on which the droplet spreads, wherein the surface and the droplet are in thermal communication; and/or of an environment that surrounds the droplet. The temperature and humidity control can provide sufficiently fast changes that can be used to affect a droplet parameter over a time course of the spreading.

The systems and methods provided herein have more fundamental application beyond the biological component aspect. For example, the systems and methods may be used to control droplet spreading on a surface to generate improved models of droplet spreading Accordingly, the method may comprise providing together a first fluid and a second fluid to form a fixative solution; providing a droplet of said fixative solution on a surface; imaging interference fringes generated by the droplet on the surface, wherein the imaging is over a time course during which the droplet spreads on the surface. Imaging may be done by one or more of video microscopy or phase contrast microscopy. A droplet parameter from the imaging step is determined and a process parameter controlled so as to generate an interference fringe pattern corresponding to a desired droplet parameter. The droplet parameters provided from this well-controlled biphasic droplet spreading may be used to predetermine process parameters for subsequent droplet spreading experiments, such as by providing pre-determined process parameters in a biological droplet spreading assay or system. This aspect is referred herein as an “empirically-determined” process parameter.

Also provided herein are devices and systems for optically recording a droplet spreading over a support surface, comprising: a support surface for supporting a droplet dynamically spreading over the support surface; an optical imager for imaging of interference fringes as a droplet dynamically spreads over the support surface; and an analyzer that analyses the interference fringes to calculate a droplet profile that changes with time of droplet spreading. An environmental chamber may enclose the support surface. A heater or heating element may connect to the support surface for controlling a droplet temperature. A moisture flux source for controlling relative humidity may be positioned within the environmental chamber or in the vicinity of the fluid droplet.

The optical imager may comprise a light source, a camera and a video recorder for recording optical images as a droplet spreads over the support surface.

The analyzer may calculate a droplet parameter that is one or more of droplet diameter; droplet lifetime; dynamic droplet profile, dynamic droplet thickness; and droplet surface thinning speed.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1. Schematic diagram of a system for optically recording droplet spreading on a surface.

FIG. 2. Change of fixative drop diameter with time in dry air on Si substrate;

maximum diameters of pure methanol and acetic acid drops with the same volume are also shown for comparison.

FIG. 3A, images, and FIG. 3B, cross-sectional profiles of fixative drop at different time points showing dynamics of drop evaporation. The sizes of the images in FIG. 3A are 40 mm; the dashed lines in FIG. 3B are used to approximate the sidewalls of the inner drops at 13.5 sec and 17.3 sec due to the lack of resolvable interference fringes.

FIG. 4. Change of film thickness and thinning speed over time at the center of the drop; the solid line shows the fitted polynomial curve used to calculate the surface thinning speed.

FIG. 5. Maximum diameter and lifetime of fixative drops at different relative humidity.

FIG. 6A is a plot of film thickness over time. FIG. 6B plots surface thinning speed at center of the fixative drops over time. Different room humidity (RH) levels are dry air, 40% and 70% RH humid air; each data point represents a constructive interference fringe order.

FIG. 7. Schematic of light paths for interference fringe formation in thin films.

FIG. 8. Images of a well-spread chromosome metaphase (left) showing a dicentric (arrow), and a poorly-spread chromosome metaphase (right).

FIG. 9. Image of a sessile fixative drop containing cells. The center cell area does not show interference fringes.

FIG. 10. Interference fringes on a 3″×2″×1 mm glass slide.

FIG. 11. Jurkat cell metaphase by phase contrast imaging.

FIG. 12A, top- and side-view schematics of a heated ITO glass slide; FIG. 12B, schematics of two moisture flux sources.

FIG. 13. Plot of maximum drop diameter as a function of methanol percentage for different RH ranging from 0% to 70%.

FIG. 14 is a flow-chart summary of a method of manipulating spreading of a fluid droplet on a surface.

### DETAILED DESCRIPTION OF THE INVENTION

In general, the terms and phrases used herein have their art-recognized meaning, which can be found by reference to standard texts, journal references and contexts known to those skilled in the art. The following definitions are provided to clarify their specific use in the context of the invention.

“Controlling” is used broadly herein with respect to droplet spreading over a surface. The control may refer to the ability to reliably affect a measurable change in a fluid droplet parameter, such as by interference fringe detection, and specifically a parameter that influences a droplet spreading characteristic or parameter.

“Biological component” refers to a material that is biological in origin and that is suspended in a fixative solution. Examples of biological component include isolated whole cells from a patient tissue or biopsy, a tissue sample, cultured cells, or portions of a cell, such as nuclear material from which chromosomes are obtained. Fixative solution refers to the liquid in which the biological component is suspended and is used broadly herein to refer to the ability to suspend the component in a solution. Accordingly, the solution need not actively cause a chemical reaction with respect to the component. The combination of fixative solution and biological component is referred herein as a “biological solution”. The fixative solution may be formed from a single liquid, such as acetic acid, or may be formed from two or more liquids, such as methanol and acetic acid. In an aspect, the fixative solution is formed from two liquids that are compositionally distinct. For example, the first and second liquids may be characterized in terms of differences in their physical properties, such as evaporation rate, volatility, the ability to take up water, hydrophobicity, hydrophilicity, hygroscopicity.

“Process parameter” generally refers to a physical parameter that affects droplet spreading, particularly a droplet parameter that can be measurably detected via a change in interference fringes. “Droplet parameter” refers to a property of the droplet that reflects droplet spreading, and that may change depending on a change in a process parameter. “Desired” in the context of droplet parameter, refers broadly to the aspect where an optimal droplet parameter is known, and that the user desires in order for a good application outcome. For example, in the context of metaphase spreads, a user may achieve a desired droplet parameter by active measuring of interference fringes and ensuring an appropriate interference fringe pattern is achieved by control of one or more process parameters. The control can be by pre-determined process parameter(s) and/or feedback control. The devices and methods described herein may be incorporated into automated systems to provide high-throughput, reliable and robust droplet spreading.

“Dynamics”, as used herein, refers to any parameter that may be time-varying or spatially-varying. For example, evaporation may not be constant but, instead, for a number of reasons may vary with time. Similarly, change in droplet diameter may not be constant with time. A powerful aspect of the instant fringe detection technique is the ability to quickly and efficiently analyze changes in the fringe order, spacing, and the like, and convert that fringe measurement to a droplet parameter, which is repeatable over time. This provides a time-course of the droplet parameter in an efficient and reliable manner.

“Selected droplet location” refers to a region of the droplet, such as at the center, and edge, or a position therebetween. This reflects that certain parameters are more relevant at specific regions. For example, contact angle with the substrate surface is relevant at a droplet edge. Thickness may be measure at the droplet center, or a defined off-center location. Droplet profile may be along a symmetrical center-line.

“Feedback loop” refers to the ongoing interference fringe-based analysis that, in turn, is used to control a process parameter to drive the fluid droplet that is spreading to a desired droplet parameter. In contrast, an “empirically-determined process parameter” refers to the system that has pre-determined operating conditions, such as process parameters, to obtain a desired outcome based on initial starting conditions, such as biological component type, amount, fixative compositions. For these initial starting conditions, the system and method provided herein describe the precise process parameters to ensure a desired outcome, such as good metaphase spread for metaphase-spread applications. Optionally, any of the methods and systems provided herein may incorporate both feedback and empirically-determined aspects. In this manner, ideal starting conditions are established, along with conditions during spreading that may be continuously or repeatedly assessed to ensure there is little or no deviation from desired spreading droplet parameter.

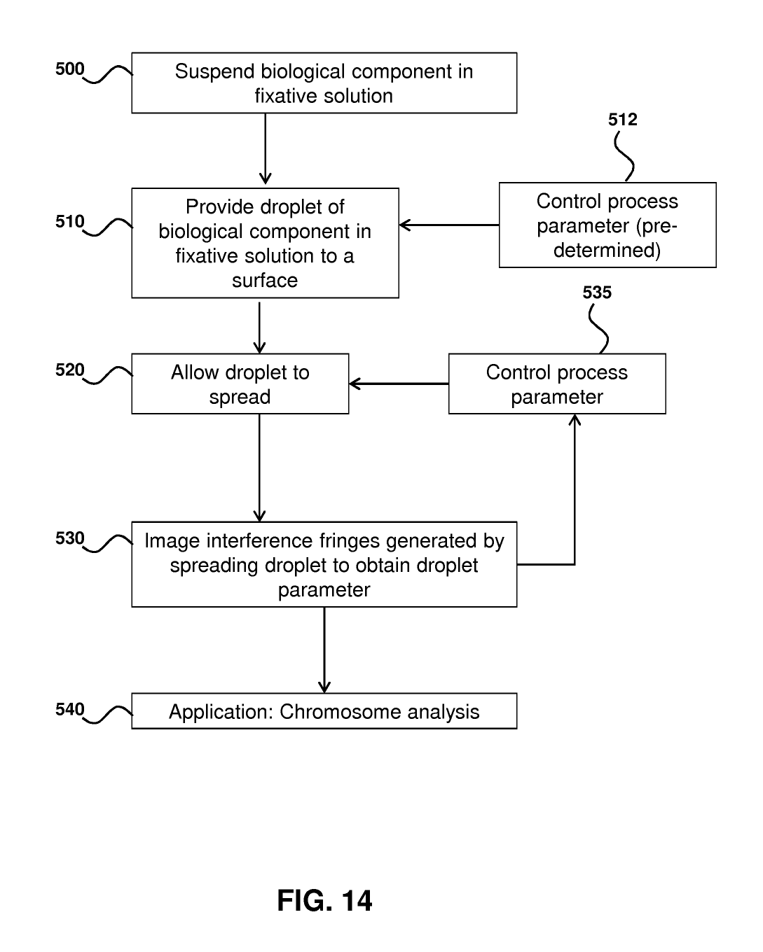

An overall flow-chart summary of a method is outlined in FIG. 14. A biological component is suspended in a fixative solution 500. A droplet of the biological solution of 500 is provided on a surface 510 and the droplet allowed to spread 520. A process parameter may be controlled during the spreading, so as to ensure desired spreading characteristics to achieve a desired end result, including by an empirically-determined process parameter as shown in step 512. Similarly, the interference fringes generated by the droplet may be imaged 530 so as to detect the actual droplet characteristics. Optionally, the actual droplet characteristics may be used to drive a feedback control 535 of a process parameter to drive the spreading to a desired droplet characteristic that is suited for the application of interest, such as chromosome metaphase analysis 540. Also provided are relevant controllers, drivers, positioners, applicators and the like to carry out of the methods provided herein. For example, temperature controllers, heaters and sensors, and similarly, humidifying components, may be employed to ensure rapid control of the process parameters of heat and humidity. Fluid applicators and controllers may be used to ensure appropriate droplet volume, droplet composition, surface coatings and the like are provided. In this manner, a desired time course of interference fringes are obtained, dependent on the application of interest.

### EXAMPLE 1

### Experimental Characterization of Methanol-Acetic Acid Fixative Sessile Drop Dynamics in Dry And Humid Air by Video Imaging and Interference Analysis

Dynamics of methanol and acetic acid (3:1 v:v) fixative sessile drop is important for metaphase chromosomal spreads in cytogenetic assays. However, it has not been well characterized by biologists from a physical science point of view. In this example, an elegant optical setup records the fixative drop spreading and evaporation process. Drop film thickness, cross-sectional profile and surface thinning speed are constructed from the observed interference patterns to show evolution of the process in both dry and humid air. Surface thinning speed analysis at the drop center suggests different evaporation regimes. The ability of characterizing fluid behavior at a scale comparable to the size of biological cells by interference fringes facilitates further understanding of the metaphase spreading process at micro- and nano-scale.

Introduction: Chromosome metaphase spread is an important preparation used in both research and clinical laboratories for cytogenetic analyses of cells for chromosome abnormalities [1-5]. It is done by dropping fixative solution (a mixture of methanol and acetic acid with 3:1 v/v ratio) containing target cells onto a substrate, and let the solution spread out and evaporate. Despite the simplicity of the dropping procedure, achieving a high quality chromosome spread is still an art with varying results between laboratories and individuals, limiting the full potential of cytogenetic techniques including their automation for broader applications.

It has been reported that many factors affect the chromosome spreading. Spurbeck et. al. used an environmental chamber and found optimal temperature and relative humidity (RH) for chromosome spread [6]. Others used water bath moisture, cooled substrate slide, and elevated temperature or even flame to dry the slide for good spread [7-9]. Some reported that a thin water layer on the slide [9,10], certain drop height and substrate slide angle [11], or increased acetic acid fraction would improve chromosome spreading [7], but others reported no or minimal effects of these conditions [8]. It is clear that all the reported factors affect the dynamics of the sessile fixative drop spreading and evaporation, which is critical to the chromosome spreading process. However, such dynamic process was only speculated by biologist, and has not yet been characterized using physical science techniques and at a scale relevant to the cell and chromosome spreading dimensions. Several groups also observed the chromosome spreading process using in situ phase contrast microscopy and identified the importance of water for cell swelling and chromosome stretching [12]; timing and duration of the spreading were also described [8,13]. Nonetheless, these conditions were not linked to the local fluid environment for a better understanding of the process, due again to the lack of drop dynamics information.

To characterize behaviors of sessile drops on solid substrates, gravimetric or optical techniques can be used. Gravimetric analysis can deduce total evaporation rate [14], but lacks size, shape and contact angle information. Several optical techniques have been used to record the size, shape, contact angle of sessile drops. For initial impact and deposition of sessile drops, high speed cameras are used [15,16]. In the case of drops that did not spread very thin, side- and top-view profiles or silhouettes of the drops are recorded by digital cameras [17-19]. An optical setup treating the drop as convex lens is also reported to characterize profile of the drops with low contact angle [20]. For thin film fluids, interference fringes can form. Interference fringes have been used to analyze the edges and the very end of life of low contact angle drops [18,21]. They are also observed in small drops (˜mm in diameter) with stronger spreading and lower surface slope [22,23], but have not been used for measuring drop dynamics in detail.

In this example, we use video imaging and interference fringe analysis to characterize the behavior of methanol-acetic acid (3:1 v:v) fixative sessile drops without involving cells. Due to significant spreading of the methanol-acetic acid liquid system, the drops spread completely with diameters over 37 mm; interference fringes show up soon (less than 10 s) after drop deposition, then covered the whole drop area and stayed for a large portion of the drop lifetime. A simple optical setup is built to record drop images and interference fringes to extract diameter, lifetime, dynamic drop profile, thickness and surface thinning speed information. Different evaporation regimes were suggested at the drop center by surface thinning speed analysis for both dry and humid air. This example is useful for assessing the effect of fixative fluid local environment on chromosome spreading at micro- and nano-scale.

Materials: Methanol and acetic acid are purchased from Sigma-Aldrich with HPCL grade (≧99.9%) and ACS reagent grade (≧99.7%) respectively. Fixative solution is prepared fresh before the experiments by mixing methanol and acetic acid at 3:1 v/v ratio and stored in a glass vial. A manual pipette is used to dispense 10 μl of fixative solution onto a substrate slide from a fixed position with pipette tip within 5 mm from the slide surface.

The substrate slides used are Si substrates cut into uniform width from a 4″ diameter Si wafer with a thickness ˜500 μm. The substrate slides are cleaned by RCA step 1 clean (water, ammonium hydroxide, hydrogen peroxide mixture with 5:1:1 ratio at 75° C. for 15 min) to render the surface hydrophilic, and then stored at room temperature until use.

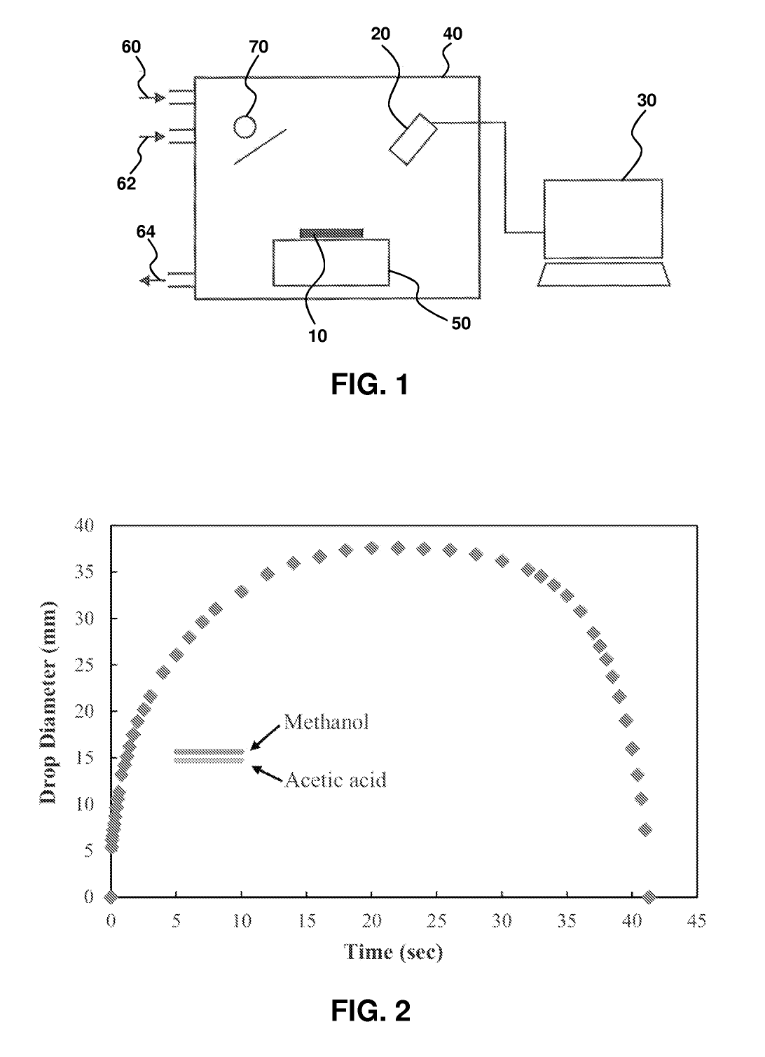

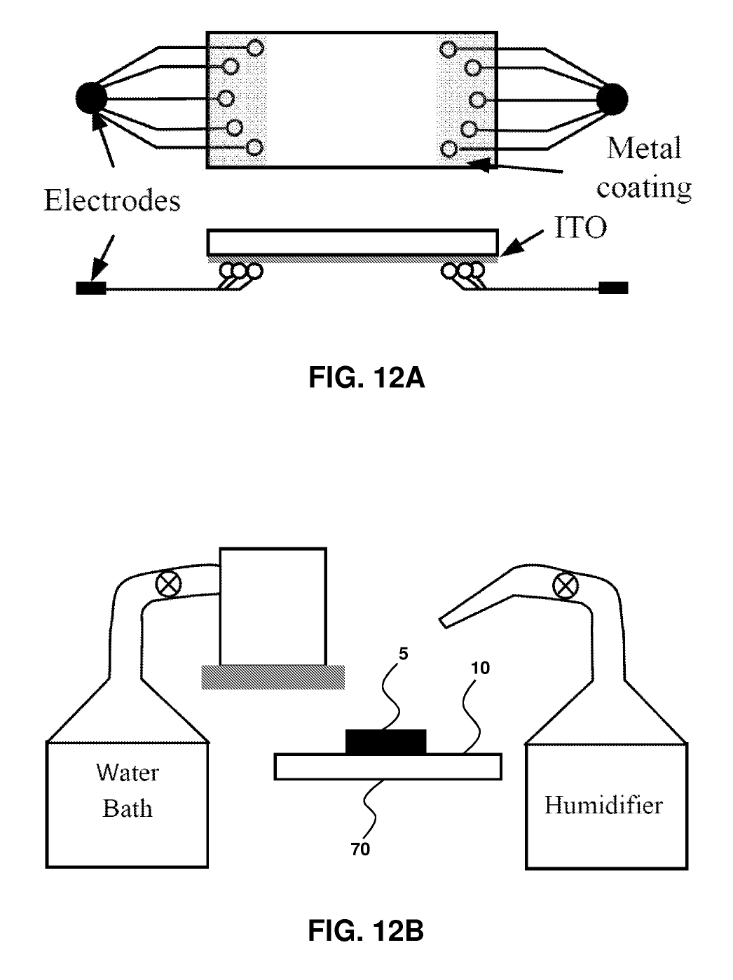

FIG. 1 shows a schematic diagram of an optical setup. The setup is positioned inside an ETS environmental chamber (Electro-Tech Systems, Inc., Glenside, Pa.) with approximately 0.368 m³ usable space. Fluorescent lamp of the chamber is used as the light source to illuminate the fixative drop on substrate slide. A cleanroom wipe is used in front of the lamp as a diffuser to uniform the illumination. A Q-See color camera (Anaheim, Calif.) oriented 30° from the substrate slide normal, and a computer with a video card and WinTV 2000 software (Hauppauge Computer Works, Inc., Hauppauge, N.Y.) are used to capture the experiments. Videos are saved as AVI files with ROB color at 30 fps. Substrate slides are placed on top of a hotplate. A ruler is taped on the hotplate surface as a scale. Fluid sample on a substrate 10 is positioned relative to an optical system 20, that may be connected to an analyzer 30, such as a computer. Environmental chamber 40 may enclose fluid sample 10,l light source 70, camera/video recorder 20, so as to provide good process parameter control. Other examples of heater and humidifiers are illustrated in FIG. 12A-12B. Humidity control may be provided by inlets 60 62, corresponding to moist air and dry air inlets, respectively, to achieve any desired humidity level and vent outlet 64. Stage or heater 50 may support substrate on which fluid droplet is placed 10. In an aspect, the volume of the environmental chamber is small, to provide rapid humidity responses, such as less than 10,000 cm³, 1000 cm³, 100 cm³ or 10 cm³.

Diameter and lifetime of the drops are measured from the videos by ImageJ software (National Institute of Health). ImageJ is also used to split the video into Red/Green/Blue channels. Interference fringes from the green channel is used for data extraction. Similar results are obtained when other channels were used. Assuming a wavelength of 540 nm for the green channel, each order of constructive interference fringe stood for a film thickness of 215.3 nm (see interference fringes and film thickness below). To determine how the liquid film thickness h changes with time at any position within the drop, light intensity at that position over time is plotted using ImageJ's “Plot Z-axis Profile” command in the menu. Interference maxima and the orders of constructive interference are identified, which are converted to the corresponding film thickness. To obtain the surface thinning speed Vₛ (i.e. ∂h/∂t, t is the time) at that position, the thickness data are fitted by polynomial using Matlab™. Vₛ is calculated as the first derivative of the fitted curve. To construct cross-sectional profile of the drop at certain time, light intensity of the drop is plotted along a horizontal line that passes the drop center and crosses the whole drop. Interference extrema are identified, and their orders and corresponding film thicknesses are obtained by correlating with the temporal intensity history of the drop.

The environmental chamber is placed under a chemical fume hood. The temperature of the chamber is controlled by the building air conditioning system, and is 23.4±0.6° C. during the experiments. Relative humidity (RH) of the chamber is adjusted by either purging the chamber with building compressed dry air, or by an ultrasonic humidifier to supply moisture to the chamber. For dry air experiments, the RH is reduced to <0.8% by compressed dry air before fixative dropping. The compressed dry air is turned off during the experiment and the RH is below 1.5% throughout the experiments. For all the experiments, a built-in fan is used to circulate the air inside the chamber. The fan is turned off during fixative spreading.

Spreading and evaporation of liquids on solid substrates is encountered in many practical processes and has been studied extensively [24,25]. For example, partial wetting small sessile droplets with slow evaporation have been studied for deposition of colloidal particles on solid surfaces [26-31]. However, pure liquids were studied in a majority of the works, and only a few are aimed at liquid mixtures [22,32] due to much increased complexity of multiple-component system. The fixative solution in this example is a binary mixture of methanol and acetic acid at 3:1 (v:v) ratio. Because methanol is completely miscible with water and acetic acid is hygroscopic, moisture in humid air is expected to condense into the drop to form a ternary system to affect the fixative spreading and evaporation. The dynamics of the binary fixative drops in dry air will be reported first, followed by the ternary system in humid air.

Spreading of fixative sessile drops in dry air: The binary methanol-acetic acid fixative drops are observed to spread completely on the substrates. FIG. 2 shows how the diameter of the fixative drop changed with time. It resembles common behavior of volatile droplet spreading on solid surfaces: the diameter of the drop keeps increasing until reaching a maximum value, then decreases to zero with continued evaporation. The maximum diameter of the drop is 37.6 mm, which is significantly larger than the maximum diameters of pure methanol and acetic acid drops of the same volume, measured to be 15.6 mm and 14.7 mm, respectively. We attribute this complete spreading to a concentration-induced Marangoni effect [22,32] (see hereinbelow: governing equations for thin sessile drops, which includes a Marangoni flow term due to surface tension gradient). TABLE I lists surface tension y, saturated vapor pressure Pᵥ, diffusion coefficient in air Dₘ, and evaporation parameter Jₒ of methanol, acetic acid and water. Methanol has lower surface tension but higher evaporation parameter than acetic acid. Because the evaporative flux is the highest at the drop edge (see hereinbelow on evaporation of sessile drops in open air), the fraction of methanol at the edge decreases the fastest so that the edge would have a higher concentration of acetic acid, hence higher surface tension. This surface tension gradient would generate a Marangoni flow that coincides with the spreading direction and results in complete spreading. Besides concentration gradient induced Marangoni effect, temperature gradient induced Marangoni effect should also exist. In general, however, surface tension gradients induced by temperature gradients are weaker than those by concentration gradients because thermal diffusion (thermal diffusivity of methanol, acetic acid and water ˜10⁻⁷ m²/sec) is a much faster process than mass diffusion process (mass diffusivity ˜10⁻⁹ m²/sec), which results in smaller temperature gradients and subsequent smaller surface tension gradients. For a concentration gradient of 12% methanol ratio change over 5 mm in the methanol-acetic acid binary mixture, the surface tension gradient would be 23 mPa (considering a concentration coefficient of 0.115 mN/m per 1% methanol ratio change [33]), which leads to a 0.23 mm/sec flow for liquid film of 10 μm thickness and 1 mPa-sec viscosity.

TABLE I
Physical parameters of methanol, acetic acid and water.

| Liquid | γ (mN/m)^{a} | Pᵥ (kPa)^{b} | Dₘ (mm²/sec)^{b} | J₀ (10⁻¹⁰ m²/sec)^{b} |
|---|---|---|---|---|
| Methanol | 22.95 | 15.56 | 15.04 | 24.50 |
| Acetic acid | 27.4 | 1.93 | 12.22 | 3.49 |
| Water | 72.75 | 2.87 | 24.7 | 3.30 |

^{a}Values at 20° C.;
^{b}Values at 23.4° C.; J₀ calculated by assuming ideal gas and zero ambient vapor pressure.

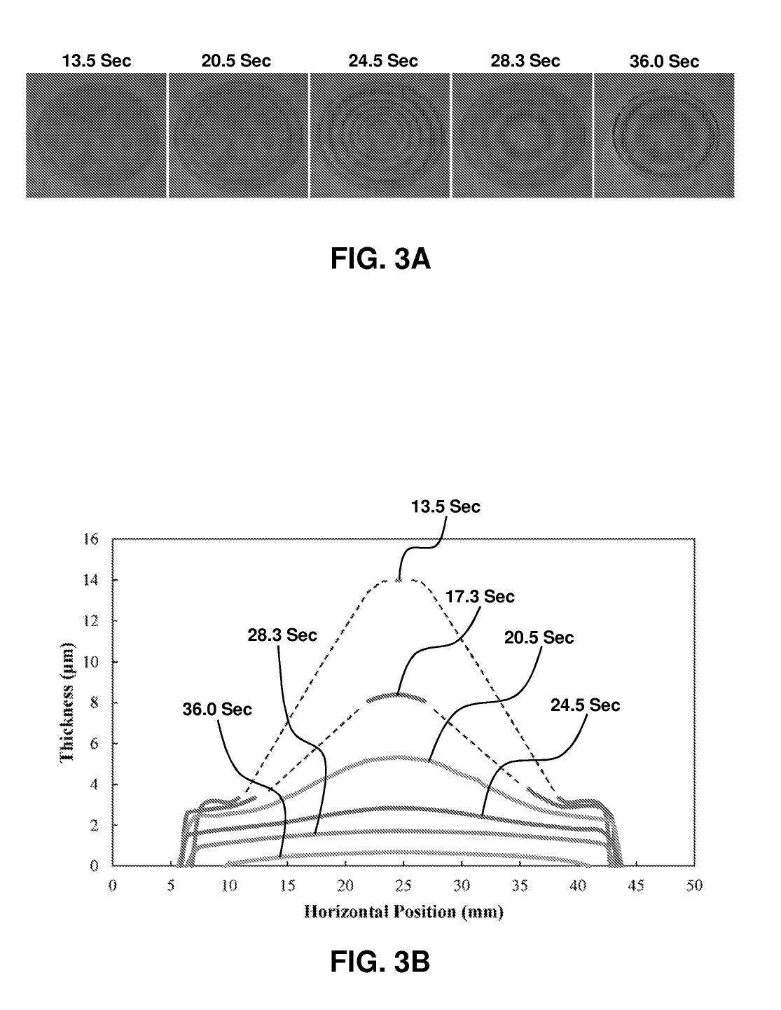

Because of complete spreading, thickness and surface slope of the drop became small quickly to show interference fringes. The recorded video reveals that color of interference showed up at the drop edge less than 3 seconds after fixative deposition. With further drop spreading, a circular band of interference fringes at the drop edge becomes pronounced at ˜13.5 sec, as shown in FIG. 3A. The band's outer edge coincided with the drop edge. The band's inner edge coincides with an inner drop that had yet to show interference fringes. To be able to resolve the interference fringes, the distance between adjacent constructive fringes has to be larger than 2 pixels. Using 215.3 nm height difference between adjacent constructive fringes and 0.235 mm/pixel resolution of the video image, the slope of the drop surface has to be smaller than 4.6×10⁻⁴ rad before interference fringes can be resolved.

The inner drop shrinks both in height and size after reaching its maximum diameter at ˜13.5 sec, which leads to interference fringes covering the entire inner drop at ˜20.5 sec. Meanwhile, the surface slope of the band increases due to faster thinning at the band's outer edge. However, the slope difference between the inner drop and the band is still clear. With further evaporation, the slope difference and the inner drop disappears completely at ˜28.3 sec, followed by the shrinking of the whole remaining drop in both height and diameter. To help better understand the dynamics of the binary drop evaporation, images of the drop at different time points are shown in FIG. 3A. Cross-sectional drop profiles by interference fringe analysis are also plotted in FIG. 3B. The spreading and evaporation process is quite repeatable. For three drops, the lifetimes and maximum diameters are measured to be 41.3±0.2 sec and 37.7±0.3 mm. Also note that the drop profiles are not drawn to scale, with horizontal positions in mm and thicknesses in μm, and corresponding contact angles on the order of 10⁻³ radian (˜0.2 degree).

The appearance of the band and the inner drop is not described previously. This is attributed to the preferential evaporation of methanol within the mixture due to the much higher evaporation rate of methanol than acetic acid. Because thickness is the smallest and evaporative flux is the highest at the drop edge, methanol is depleted quickly close to the edge to form a thin acetic acid-rich band. The inner drop would stand for the center thick area where methanol was yet depleted. The disappearance of the inner drop indicates the depletion of most methanol, followed by the evaporation of the remaining “acetic acid-rich” sessile drop. This is consistent with previous hypothesis that methanol is depleted first to allow cellular swelling in metaphase spreading [12].

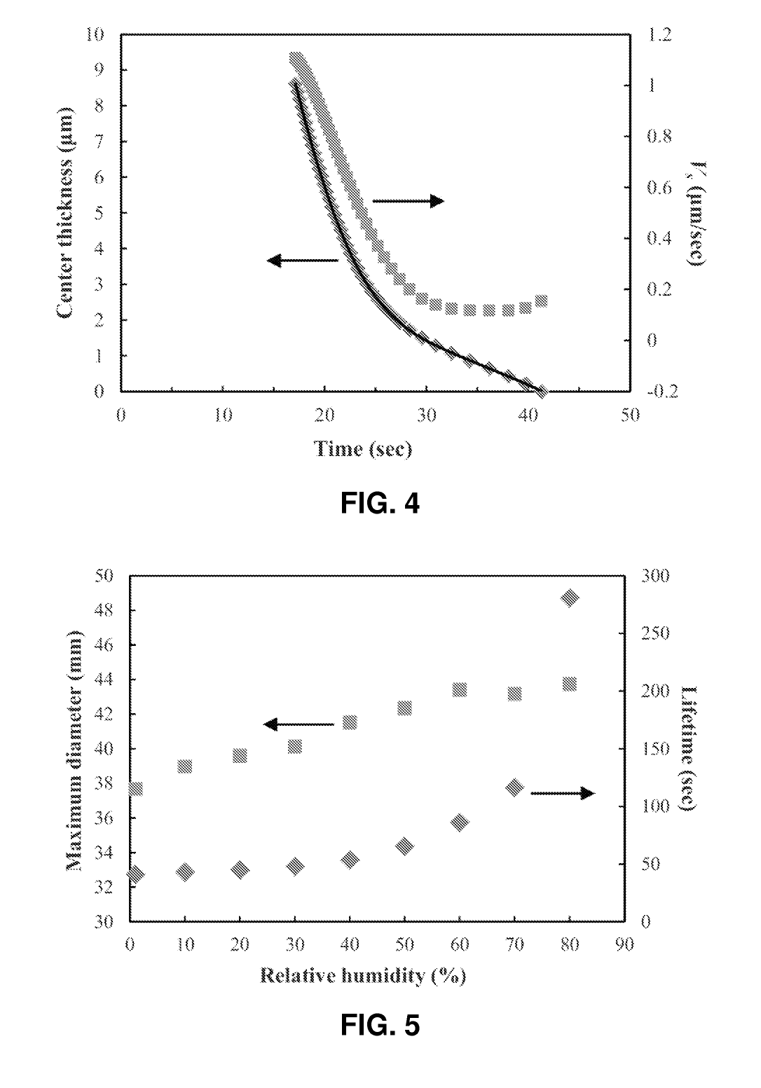

Surface thinning speed 14 is an important parameter affecting the quality of the metaphase spreads [34], but has never been measured in the literature. With the interference fringe technique, change of film thickness over time at any position within the drop can be constructed after appearance of the interference patterns, which allows measurement of the surface thinning speed. Here, film thickness and surface thinning speed at the center of the drop is constructed and plotted in FIG. 4 to show more insight of the fixative evaporation process. It can be seen that Vₛ had an initial value of 1.1 μm/sec at ˜17.3 sec, decreased over time, then started to level off at ˜28.3 sec, and finally increased a little at the very end of the drop life.

From Eq. (B1) and (B2) below, Vₛ is determined by evaporation and the local mass loss due to radial fluid flow generated by Laplace pressure, hydrostatic pressure, disjoining pressure and Marangoni surface tension gradient. Because of the complexity of the spreading and evaporation of the binary system, it is expected that component fraction in the drop is not uniform but a function of time and location. The volume of drop at 17.3 sec is estimated as 4.3 μL from the drop profile. Methanol should make up of a large portion of the evaporated 5.7 μL due to its large evaporation rate and initial volume fraction, which suggests a methanol volume fraction lower than 75% at 17.3 sec. However, without knowing the exact methanol-acetic acid fraction ratio, we use the evaporative flux of a methanol-acetic acid (3:1 v:v) drop with a 14 mm diameter (the size of the inner drop at 17.3 sec) as an upper bound for the evaporation induced surface thinning. It has been found recently that natural convection is significant in addition to diffusion in evaporation of large sessile drops [14]. The total evaporation rate can be obtained by multiplying the diffusion induced evaporation rate with a correcting factor to compensate for air counter diffusion and natural convection. Assuming the same correcting factor can be used on the local evaporative flux calculation, and total evaporative flux be the sum of individual component evaporative flux weighted by their volume fraction, the upper bound of evaporation induced surface thinning at the drop center can be calculated to be 0.545 μm/s, on the same order as the measured V. For liquid film of several microns thick, disjoining pressure is not significant. By curve fitting the drop surface profile using Matlab™, Laplace pressure is found to be on the order of ˜mPa, similar to the hydrostatic pressure. Both are too small to contribute to the surface thinning speed for millimeter-sized micron-thick thin films. It is estimated that solutal Marangoni flow could be large enough to contribute to the surface thinning speed. However, it is not straightforward to deduce the Marangoni flow and component fraction ratio information from drop film thickness and surface thinning speed. Real-time measurement of binary component fraction over the drop area is another route, but can also be challenging. Further work is needed to more clearly understand the effect and magnitude of the Marangoni flow in this process.

Vₛ is observed to decrease monotonically before leveling off. Decrease of Vₛ is explained by the reduced methanol fraction in the mixture due to evaporation, assuming evaporative flux of each component in the mixture is approximated to be its pure evaporative flux multiplied by its volume fraction. Leveling off of the speed is an indicator of the “acetic acid-rich” regime. The leveling off surface thinning speed was ˜120 nm/sec. As a comparison, evaporative flux for pure acetic acid by the diffusion and natural convection model is calculated to be 69 nm/sec using a radius of 15.4 mm at 36 sec, within a factor of 2 from the measured value. The final increase of the speed may arise from the reduced drop size at the end of the drop life.

Spreading of fixative sessile drop in humid air: It is found that fixative drops also spread completely in humid air. FIG. 5 shows how the maximum drop diameter and the drop lifetime changed with RH. The maximum drop diameter increases from 37.7 mm in dry air to 43.4 mm at 60% RH, then remains relatively unchanged for higher RH. Increase of maximum diameter with RH could be explained by the additional Marangoni flow generated by the condensation of moisture into the drop. Surface tension of water is much higher than both methanol and acetic acid. Similar to evaporation, water condensation flux is also the highest at the drop edge, which generates a Marangoni flow along the drop spreading direction to increase the maximum drop diameter. However, the maximum diameter cannot be increased infinitely because of limited drop volume and fast methanol evaporation, which explains the saturation of the maximum diameter after 60% RH.

FIG. 5 also shows that the lifetime of the drop increases with RH and rises rapidly at high RH. In humid air, moisture condenses into the methanol-acetic acid drop. Because methanol has much higher evaporation parameter than both acetic acid and water, it is still expected to be depleted first during evaporation, similar to what happens in dry air. The evaporation parameters of acetic acid and water are similar if ambient vapor pressure is zero. The moisture in the air, however, reduces the evaporation parameter value of water and lets acetic acid evaporate faster than water. This provides a “water-rich” regime at last stage of the drop life after most of the methanol and acetic acid are evaporated. In this regime, the water evaporation time is inversely proportional to the evaporation parameter, which is proportional to the water vapor pressure difference between the drop surface and the environment (see Eq. (C1) and (C2) below). As RH rises towards 100%, the water vapor pressure difference goes to zero and the evaporation time goes infinite. Cooling of drop surface due to evaporation can further reduce the pressure difference and increase the evaporation time [25].

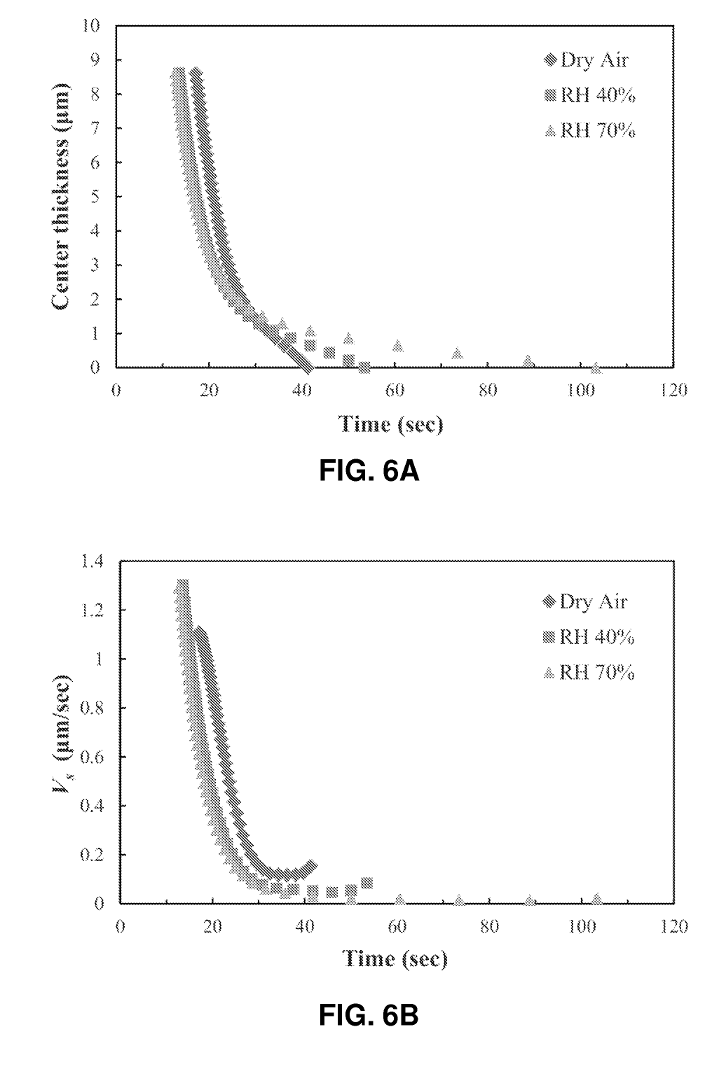

To better understand the effect of humidity, film thicknesses and surface thinning speeds at center of the drops are plotted for 40% and 70% RH in FIG. 6A and FIG. 6B by interference fringe analysis. Data in dry air are also plotted for comparison. FIG. 6A shows that when RH increased, the time for the drop center to thin to a thickness higher than ˜2 to 3 μm decreases. This could be a result of stronger Marangoni spreading in higher RH air to thin the drop. Another possibility would be that large heat generated by water condensing into the drop could accelerate the evaporation of fixative solution. Such phenomenon is observed in the evaporation of alcohol droplets in humid air [35]. For both 40% and 70% RH, the surface thinning speed at film thickness larger than ˜2 pm is higher than the speed in the “acetic acid-rich” regime in dry air, indicating a methanol dominated evaporation. The “inner drop” phenomenon is also observed in all RH cases. The disappearance of the inner drop occurs at the drop center thickness of ˜2 μm, which also supports a “methanol dominated evaporation” regime when the film is thicker than ˜2 μm.

With further evaporation, there is a crossover point and thickness decreases much slower at higher RH. Similar to that in dry air, the surface thinning speeds also level off in humid air, but with a smaller value (˜120 nm/sec in dry air, ˜50 nm/sec for 40% RH, and ˜18 nm/sec for 70% RH). This level-off could indicate the “water-rich” regime discussed above where the evaporation rate is greatly reduced by the moisture in the air. This regime occurs at a film thickness ˜1.3 μm (equivalent to the 6^{th} order constructive interference fringes) or less. The curves also show that Vₛ keeps decreasing within the “water-rich” regime, suggesting further evaporation of residual acetic acid. As in dry air, Vₛ also increases at the end of the drop life due to quick shrinking of drop size in both 40% and 70% RH air. In addition, this “water-rich” regime is responsible for the dramatic drop lifetime increase at high RH due to the slow evaporation rate.

Dynamics of methanol and acetic acid (3:1 v:v) fixative sessile drop is important for metaphase spreads for cytogenetic assays. It is a complex process and has not been well characterized by biologists from a physical science point of view, limiting reproducible control and possible automation of the process. In this example, a simple optical setup is constructed to record the dynamics of the fixative drop spreading and evaporation. The drops are found to spread completely on the Si substrates in both dry and humid air. Drop film thickness, cross-sectional profile and surface thinning speed are constructed from interference patterns to show the dynamics of the drop evaporation. An “inner drop” is observed in the “methanol dominated evaporation” regime. “Acetic acid-rich” and “water-rich” regimes are also indicated by leveling off of the surface thinning speed in dry and humid air. Because of the complete spreading, interference fringes exists in a large portion of the drop lifetime. Preliminary results using Jurkat cells (ATCC, Manassas, Va.) indicates that metaphase occurs within the regime that can be analyzed by interference patterns. The effect of fluid environment on cell metaphase spreading using the fluid dynamic information generated by the interference fringe analysis is underway, for design of a better and more robust metaphase spreading process with attendant workflow automation.

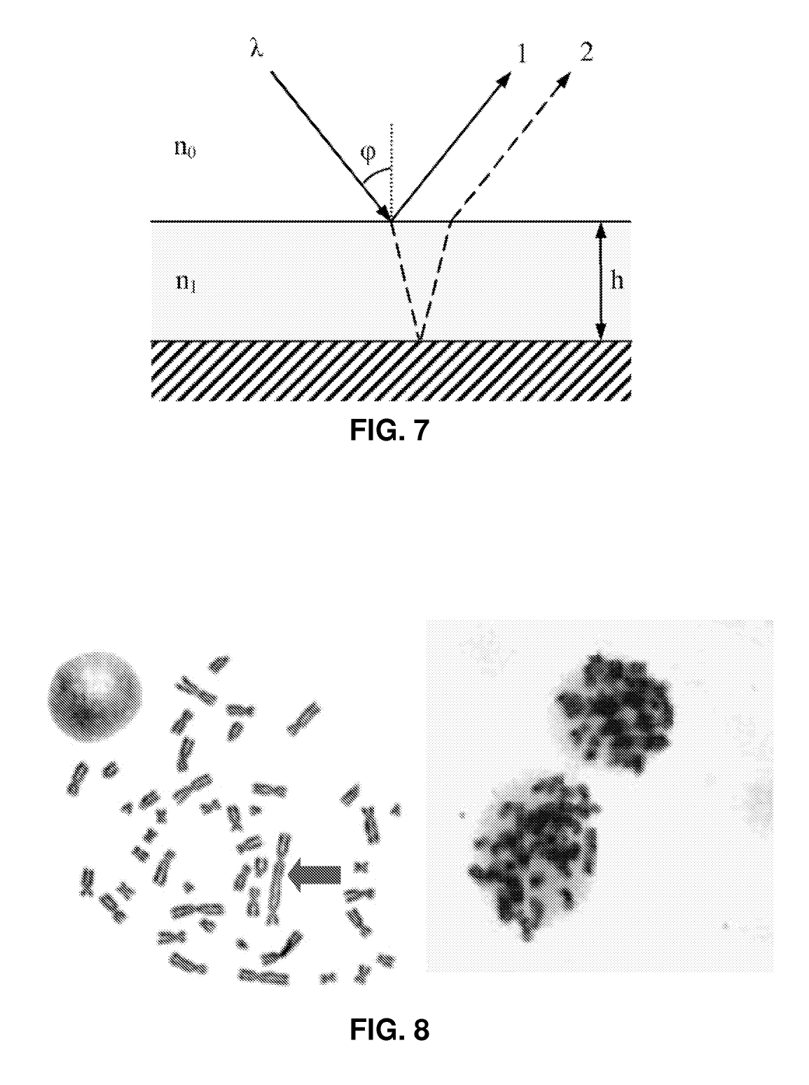

Interference fringes and film thickness: As shown in FIG. 7, for a film with a thickness of h, an incident light with an angle of φ to the normal of the film surface will generate two beams: one is reflected by the top surface of the film; the other is reflected by the liquid/solid interface and refracted twice by the liquid top surface. For constructive interference with the two beams, the thickness of the film should equal:

$$h = N * \frac{λ}{2 \sqrt{{n}_{1}^{2} - {( {n}_{0} sin ϕ )}^{2}}} , N = 0 , 1 , 2 , 3 … \qquad ( A1 )$$

where A is the light wavelength, n₀ is the refractive index of incoming light medium (1 for air), n₁ is the refractive index of the liquid, N is the order of the constructive fringes.

Because of the small contact angle in completely spread drop, the effect of the film slope on incident angle is neglected. After splitting the video into red/green/blue channels, green channel is used to calculate the drop film thickness. Assuming a wavelength of 540 nm, refractive indexes of methanol, acetic acid and water are 1.3382, 1.3777 and 1.3349 respectively at room temperature. For simplicity, average of the refractive indexes is used in the calculation, which is 1.3503. This introduces an error with standard deviation of 0.0238, which would result in an error of 2% in film thickness. For the 30 degree incident angle in our experiments, the thickness difference is 215.3 nm between adjacent constructive interference fringes. With 1 degree uncertainty in the incident angle, the measurement uncertainty in the film thickness is ˜0.5%.

Governing equations for thin sessile drops: For thin sessile drops, lubrication theory applies. Assuming the drop has radial symmetry, the governing equations for the drop fluid are as follows:

$$\begin{matrix}\frac{\partial h}{\partial t} + ∇ ( hU ) = - J ( r ) & ( B1 ) \\ U ( r , t ) = \frac{{h}^{2}}{3 η} ∇ ( γΔ h - ρℊ h + Π ( h ) ) + \frac{h}{2 η} ∇ γ & ( B 2 )\end{matrix}$$

where h≡h(r,t) is the local liquid film thickness at radius rand time t, U≡U(r,t) is the local average horizontal flow velocity over the film thickness, η is the viscosity, γ is the surface tension, J(r) is the local evaporative flux. Eq. (B1) is the local mass conservation equation. In Eq. (B2), γΔh is the Laplace pressure; ρgh is the hydrostatic pressure and can be neglected for thin films; Π(h) is the disjoining pressure and is only significant when film thickness is less than ˜100 nm;

$$\frac{h}{2 η} ∇ γ$$

is the Marangoni velocity.

Sessile drop evaporation in open air by diffusion and natural convection: For one component system, with the assumptions that 1) evaporation is controlled by diffusion; 2) diffusion is quasi-stationary (quiescent air); 3) evaporation is an isothermal process; 4) size of the drop is smaller than the capillary number (usually several millimeters) or the contact angle is small so that the drop shape is a spherical cap; and 5) evaporation is not at the end of the drop life and disjoining pressure can be neglected, the evaporation of sessile drop follows a “D²” law and an analytical solution is available through the analogue of a biconvex conducting lens of a given angle [25]. For small contact angle, the evaporation follows equations:

$$J = {J}_{0} \text{/} \sqrt{{R}^{2} - {r}^{2}} {J}_{0} = \frac{2}{π} {D}_{m} ( {ρ}_{surf} - {ρ}_{∞} ) \text{/} {ρ}_{L} {E}_{d} = - {ρ}_{L} \frac{d V}{d t} = {ρ}_{L} 2 π {RJ}_{0} = 4 {RD}_{m} ( {ρ}_{surf} - {ρ}_{∞} ) \qquad ( C1 )$$

where J is the local evaporative flux at radial distance r of the drop with a radius of R, J₀ is the evaporation parameter, Dₘ is the mass diffusion coefficient of the vapor molecules in air, ρ_{surf} is the vapor density at the drop surface, ρ_{∞}is the vapor density of the component in surrounding environment, ρ_{L}, is the density of the liquid, E_{d} is the total evaporation rate by vapor diffusion. Assuming ideal gas for the vapor and air, then

$$( {ρ}_{surf} - {ρ}_{∞} ) = \frac{( {P}_{v} - {P}_{∞} ) {M}_{v}}{{R}_{u} T} and {E}_{d} = \frac{4 {RD}_{m} {M}_{v} ( {P}_{v} - {P}_{∞} )}{{R}_{u} T} \qquad ( C2 )$$

where Pᵥ is the vapor pressure at the drop surface, which equals to the saturated vapor pressure at the system temperature T, P_{∞}is the ambient vapor pressure, Mᵥ is the molar mass of the component, Rᵤ is the ideal gas constant. Condensation can also be calculated by Eq. (C1) and (C2), but with P_{υ}<P_{∞}.

It has been reported recently that natural convection can be significant in addition to diffusion in evaporation of large sessile drops[14]. For P_{∞}=0, the total evaporation rate of the drop E_{dc} can be calculated by multiplying E_{d} with a correcting factor α:

$${E}_{dc} = {E}_{d} α α = [ \frac{{P}_{A}}{{P}_{v}} ln \frac{1}{1 - ( {P}_{v} \text{/} {P}_{A} )} ] \{ 1 + {0.310 [ \frac{{P}_{v} {M}_{v} ℊ}{( {P}_{A} - {P}_{v} ) {M}_{A} {v}_{a}^{2}} ]}^{0.216} {R}^{0.648} \} \qquad ( C3 )$$

where P_{A}, V_{A}, νₐ are the pressure, molar mass, kinetic viscosity of air, and g is the gravitational acceleration.

### EXAMPLE 2

### Biological Components Suspended in Fluid

Radiological and nuclear terrorism has been a threat with increasing concerns for the nation and the world. There is an urgent need to have adequate infrastructure to rapidly assess radiation injury in such a mass casualty scenario. Dosimetry measurement after a radiation incident will be an immensely helpful tool in order to triage the large number of individuals affected, guide their medical treatments and assess long term radiation risks. Dicentric chromosome assay (DCA) is the “gold standard” of biological dosimetry, but classical DCA is labor intensive and time consuming. Recently, several strategies have been developed to increase the throughput of the method for mass radiation casualty applications, such as automation of cell culture and dicentric scoring, reduced metaphase scoring number at expense of sensitivity, and international network of collaborating labs with standardized assay. However, there is still a missing link in the assay development, i.e. that a critical step in DCA, chromosome metaphase spreading, is currently poorly understood. Metaphase spread is done by dropping methanol and acetic acid mixture fixative solution containing cells onto a glass slide and letting the solution spread out and evaporate. Despite the simplicity of the process, achieving a high quality chromosome spread is still an “art” with varying results between laboratories and individuals. Wasted cell-dropping with poor metaphase spreads will slow down the assay and can be detrimental if limited cell sample is available. Many experiments have shown that fixative fluid spreading and evaporation dynamics is important for good metaphase spread. However, such processes are only described by biologists empirically and have not been characterized from physical science point of view and at a scale relevant to the cell and chromosome spreading dimensions. Cell and chromosome spreading are also studied by in situ phase contrast microscopy, but further insight to the process is limited due to the lack of knowledge on the cell local fluid environment, as well as additional experimental capabilities to further test critical hypothesis of water-induced swelling during metaphase spreading. Recently, we developed a video imaging and interference fringe analysis method that can characterize fixative drops at a scale similar to the size of the cells. Different evaporation regimes due to different component of the fluid mixture were identified. We also propose using heated glass substrate and external moisture flux sources for in situ phase contrast microscopy to further test and characterize effects of water induced cell swelling on cellular behavior of relevance for metaphase spreading.

The combination of interference fringe analysis of fixative drop dynamics and the new in situ phase contrast microscopy facilitates understanding cell local fluid environments and key parameters during metaphase spreading, and eventually leads to a predictive and robust process for high quality metaphase spreads.

Characterizing chromosome metaphase spread processes by interference fringe analysis and in situ phase contrast microscopy. Three common scenarios of metaphase spreading processes are identified. Interference fringe analysis of cell-free fixative drop is used to infer cell local fluid environment during spreading. Heated glass slide and moisture flux sources are designed and fabricated for in situ microscopy study to further test the water-induced cell swelling hypothesis. Relevant parameters of each scenario, as well as effects of reagent component variation on both fluid dynamics and quality of metaphase spread are studied, to further inform process design.

Testing of new design, final optimization, and demonstrating the final optimized process for dicentric identification. A final optimized metaphase spreading process is described and optimized. Ex vivo blood irradiation by a LINAC source is used to demonstrate dicentric identification using the newly optimized process, and compared with the traditional process.

A successful outcome of these aims result in the design knowledge and a predictive process for high quality metaphase spread and better dicentric identification. Future direction relates to the interface and integration of the process to other automated dicentric assay infrastructures in a high throughput fashion, e.g. a small footprint 96-well plate spreading process, and validation of the process for automatic scoring and DCA dosimetry. The developed processes also have applications in cancer research and clinical diagnostics.

In recent years, the threat of a radiological or nuclear terrorist attack has been of increasing concern for the nation and the world. There is an urgent need to have adequate infrastructure to rapidly assess radiation injury in such a mass casualty scenario. Dosimetry measurement after a radiation incident will be an immensely helpful tool in order to triage the large number of individuals affected, guide their medical treatments and assess long term radiation risks [1,2].

Currently, multiple techniques are available or under development for dosimetry measurement. They are either physically-based, such as electron paramagnetic resonance (EPR), or biologically-based, including cytogenetic assays, nucleic acid assays, hematological assays and protein marker immunoassays [1,2]. However, no single technique fulfills the criteria of an ideal dosimeter, and it is proposed that a combination of techniques be used to address the needs of different exposure scenarios [3].

Among different techniques, dicentric chromosome assay (DCA) is considered as the “gold standard” of biological dosimetry because of its sensitivity and accuracy [4]. Dicentric chromosomes are almost exclusively induced by ionizing radiation. The spontaneous frequency of dicentrics is very low in healthy general population. Dicentric frequency in peripheral blood lymphocytes shows a clear linear quadratic dose relationship up to ˜5 Gy for acute photon exposure with sensitivity down to 0.1 Gy [5]. The reliability and capability of the assay have been demonstrated over the years of experiences.

However, a drawback of classical DCA is that it is labor intensive and time consuming. Several strategies have been developed to increase the throughput of the method for mass radiation casualty applications: lymphocyte cell culture [6,7] and dicentric scoring [8-10] were automated; the number of dicentrics scored was reduced at the expense of sensitivity for triage application [11-13]; international network of collaborating laboratories was also formed with standardized assays and successful frequent intercomparisons [13,14].

Despite the efforts mentioned above, there is still a missing link in the assay development, i.e. that chromosome metaphase spread, a critical preparation step in DCA, is currently poorly understood. Chromosome metaphase spread is traditionally done by dropping Carnoy's fixative (methanol and acetic acid 3:1 mixture) containing cells onto a glass slide and let the solution spread out and evaporate. Even though a very simple process, achieving a high quality chromosome metaphase spread is still an “art” with varying results between laboratories and individuals. Wasted cell-dropping with poor metaphase spreads will slow down the assay and can be detrimental if limited cell sample is available, such as high throughput finger prick blood is used [7]. FIG. 8 shows images of a well-spread chromosome metaphase with a dicentric (left) [15] and a poorly-spread chromosome metaphase (right) [16].

It has been reported that many factors affect the chromosome spreading. Spurbeck et. al. used an environmental chamber and found optimal temperature and relative humidity (RH) for chromosome spread [17]. Others used water bath moisture, cooled substrate slide, and elevated temperature or even flame to dry the slide for good spread [18-20]. Some reported that a thin water layer on the slide [20,21], certain drop height and substrate slide angle [22], or increased acetic acid fraction would improve chromosome spreading [18], but others reported no or minimal effects of these conditions [19]. It is clear that all the reported factors affect the dynamics of the sessile fixative drop spreading and evaporation, which is critical to the metaphase chromosome spreading process. However, such dynamic process was only described by biologist empirically, and has not yet been characterized using physical science techniques and at a scale relevant to the cell and chromosome spreading dimensions.

In situ phase contrast microscopy is a technique that has been used to demonstrate the importance of water for cell swelling in a pure static acetic acid solution [16]. But this swelling has not been shown clearly during metaphase spreading process. Stretching of DNA and timing of the cell spreading were also reported [18,19,23]. However, further insight to metaphase spreading is limited due to the lack of knowledge on the cell local fluid environment, as well as additional experimental capabilities for in situ microscopy (such as heated substrate and external moisture flux source) to study the critical water-induced swelling process during metaphase spreading.

The video imaging and interference fringe analysis described in Example 1 can reveal the dynamics of cell-free fixative sessile drop spreading and evaporation. Fixative sessile drops can be characterized at a thickness similar to the size of the cells (thickness from ˜10 μm to submicron comparing with human lymphocyte size ˜10 μm). FIG. 1 shows the schematic of the optical setup. The system may be housed inside an environmental chamber (Electro-Tech Systems, Inc., Glenside, Pa.) that can control and change temperature and humidity. A camera is used to record the fixative drop with interference fringes. By counting the order of the interference fringes, profile of the sessile drop can be fitted in software such as Excel™ or Matlab™. FIGS. 3A and 3B show images as well as the fitted shape/profile of a fixative drop at different time points. A unique “methanol-rich” inner drop is observed. The images show colored interference fringes from the white light source. To determine the drop surface profile, the images are split into Red/Green/Blue channels and green channel is used to calculate the thickness of the drop. FIG. 6A shows how the drop center thickness changed with time for different relative humidity. From the curves, a “methanol-rich” evaporation regime could be identified for drop center thickness above ˜2 μm, and a “water-rich” evaporation regime could be identified for center thickness below ˜1 μm. The “water-rich” regime also explains the dramatic lifetime difference of the drops.

For a fixative drop containing harvested cells, cells are usually confined within the center of the drop with a diameter less than half of the maximum drop diameter

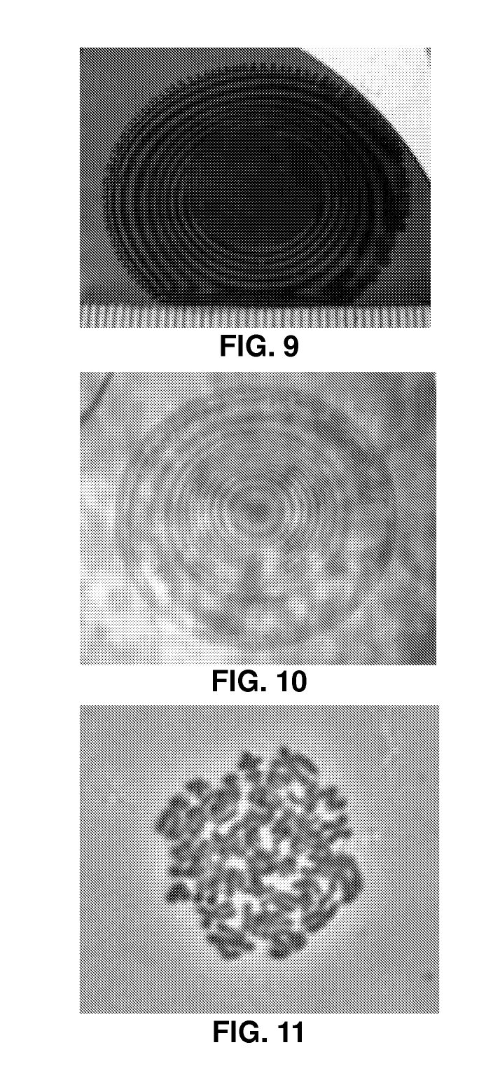

(FIG. 9). Depending on the density of the cells, the center cell region shows a grainy look that prevents the formation of interference fringes. To picture the local fluid environment surrounding the cells during metaphase spread, the fixative thickness and evaporation regime of the center cell region is estimated using the corresponding cell-free fixative drop as a first order approximation. More advanced models can be further developed involving cell shapes, contact angle and capillary pressure of fixative to the cells.

Furthermore, we use a temperature-controlled substrate, such as a heated glass substrate and external moisture flux sources in in situ microscopy to test hypothesis by Claussen et al. [16] that good metaphase spread involves swelling of cells and stretching of DNA by introducing water after preferential methanol evaporation, followed by the flattening of the cells and chromosomes.

The combination of the new in situ phase contrast microscopy and using cell-free fixative drop as a reference facilitates understanding of cell local fluid environments and key parameters during chromosome metaphase spreading, and leads to a predictive and robust process for high quality metaphase spreads.

As discussed, there are many ways to prepare metaphase spread. We focus on three main scenarios that are mostly used for high quality metaphase spread to characterize and understand the cell and chromosome spreading process. The experiments are conducted inside an environmental chamber. With better understanding of the process from these experiments, new process are proposed and tested.

Slide-making is performed inside an environmental chamber. The humidity and temperature are varied. There should exist an optimum range of humidity and temperature for high quality metaphase spread [17,24].

Melt the frost of the slide previously stored in a freezer with breath. Drop the cell suspension onto the slide from certain height, dry the slide in gentle heat. (IAEA DCA protocol [25])

Cell suspension is dropped on slide in ambient. Moisture is introduced to the drop at certain time after initial evaporation. Then the slide is heated dry to get well-spread metaphase. This is designed to mimic both Henegariu's work [18] that after initial evaporation, moisture was added from a water bath for several seconds and the slide was dried at elevated temperature; and Deng's work [19] that after initial evaporation, the slide was placed into a water bath on a heated substrate. It also allows in situ phase contrast microscopy to further test Claussen's hypothesis.

Substrate: Si is a good substrate to form strong interference fringes due to its highly reflective surface. However, for in situ phase contrast microscopy, transparent substrate is used. The interference fringes on transparent substrate are usually weak due to high background light. By reducing the background light level, we successfully observe interference fringes on glass slide substrate (FIG. 10). In this example, glass is the primary substrate.

Biological samples and protocols: Lymphocytes from human peripheral blood are the targeted sample for DCA biodosimetry and are used in this example. Cell lines can be a good alternative to precious human blood sample for understanding the metaphase spread process. Jurkat cell line (human T lymphocyte cell line, from ATCC, Manassas, Va.) is used. It has a size of ˜11.5 μm, similar to that of the phytohaemagglutinin (PHA) stimulated T lymphocyte from peripheral blood (˜10 μm). It also has the same chromosome number of 46 at metaphase as the peripheral blood T lymphocytes from healthy human. Other common cell lines may also be tested, such as HeLa cells. For peripheral blood lymphocytes, we plan to have 20 volunteers, 10 male and 10 female (non pregnant) healthy adults. Blood sample collection, preparation and cell harvesting will follow the international standards recently published by IAEA [25] and ISO [26] for cytogenetic biodosimetry assays with IRB approval. 30 mL of peripheral blood is drawn into commercial sterile vacutainers with preservative free lithium heparin as anticoagulant by a phelobotomist, and then transported for processing.

Triple packaging is used with coolant or room temperature packs to keep the blood sample at 18-24° C. during transport. The lymphocytes are separated from blood using commercial Ficoll Hypaque column, then cultured and harvested according to the IAEA protocols for dicentric assay. Briefly, cells are cultured in MEM medium with antibiotics, PHA, heat inactivated fetal calf serum at 37° C. and 5% CO₂ for 48 hours. The choice of medium is to minimize the number of second in vitro metaphase (M2) cells. BrdU will also be added if fluorescence plus Giemsa (FPG) staining is needed to exclude M2 cells. Colcemid is added at 45 hours to arrest the cells at metaphase. Cells are treated by 0.075 M KCl hypotonic solution, and then fixed in fresh Carnoy's fixative with three washes. The supernatant in the last fixative wash is used for cell-free fixative drop reference since it is the same fixative as in the cell suspension. The final cell suspension can be used for slide making experiments, or stored for future use. Storage conditions are tested. For Jurkat cell lines, cells are cultured according to the manufacture's instruction, and harvested the same way as peripheral lymphocytes. Cell metaphase spreads can be stained by FPG, Giemsa, or C-banding for imaging, or just imaged by phase contrast microscopy. FIG. 11 shows a phase contrast image of a Jurkat cell metaphase.

In situ phase contrast microscopy is by an inverted phase contrast microscope (such as the Nikon TS100) and dedicatedly housed inside our environmental chamber. Cell suspension will be dropped on the glass slide mounted on the microscopy stage. Metaphase dynamics in the field of view is recorded using a system similar to an interference fringe recording system, with a frame grabber from Hauppauge Computer Works Inc, WinTV software and an analog TV camera. The timing and process of cell swelling and flattening is recorded.

Cell-free Interference fringe analysis: the existing video recording setup is realigned to record the fixative drop on the glass slide on the inverted microscope stage.

Heated glass slides and external moisture flux sources: Heated glass slides: In situ microscopy requires a transparent heated substrate. We use Indium-Tin-Oxide (ITO) coated glass slide, which is commercially available (e.g. NanoCS, New York, N.Y.). ITO is a transparent conductive material that allows Joule heating of the glass slide. A live cell imaging system from Bioptechs Inc. (Butler, PA) has an ITO coated heated glass substrate of 1″ diameter and is used for fixative drop smaller than 1″ diameter. For larger drops, the heated glass substrate may be custom-made (FIG. 12A). A substrate holder contains electrodes that will contact with ITO. Metal coating at the electrode contact area can improve heating uniformity. COMSOL simulation assists with uniform heating design. The small thermal mass of the glass slide makes quick heating possible (estimated 7° C./sec for a 24V power supply for a square slide with 10 Ω/resistance). The temperature uniformity of the slide can be checked experimentally using a FLIR ThermaCAM EX320 infrared camera. A proportional-integral-derivative (PID) controller is used as the control loop feedback to control the heating and final temperature of the substrate. Our center has an electronics lab and previous experience of bioinstrumentation on a rapid DNA forensic analyzer that consists of a heating module for microfluidic on-chip polymerase-chain-reaction (PCR) [28].

Moisture flux sources: Controlled moisture flux source. We test two types of moisture flux sources (FIG. 12B). The first one is a transparent box connected to a warm water bath. The water vapor pressure inside the box corresponds to the saturated vapor pressure at the box temperature. To introduce moisture to the sample slide, the bottom cover of the box is removed and the box put to the stage to cover the slide for a desired time, and then removed. This will allow the uninterrupted recording of the drop interference fringes. A valve can be used to prevent excess water condensation in the box between the experiments. Extra moisture flux can be generated by boiling the water bath. The second one is a nozzle spray connected to an ultrasonic humidifier, which uses a metal diaphragm vibrating at ultrasonic frequency to generate cool fog of ˜1 μm sized water droplets. This cool fog is sprayed above the sample. The fog intensity can be adjusted by humidifier power. The spray angle and height are optimized.

Characterizing the effects of key parameters for high quality metaphase spread:: Humidity and temperature. Humidity is varied from dry air to 80% relative humidity (RH), which covers the optimum RH of ˜50%. The temperature is varied from room temperature to 50° C., which is the high end of outside temperature.

Breath length, slide temperature at initial drop contact, environmental humidity and temperature, slide heating timing and power. Breath melting frost forms a thin layer of water on the slide surface. Water can further condense or evaporate depending on the slide temperature and humidity. Amount of water is estimated theoretically and may also be checked by ellipsometry. Temperature of the slide affects fixative evaporation rate and is measured by a thermocouple sensor. For convenience, we use room temperature, and vary RH. Selection of timing for heating is based on the in situ phase contrast study. Heating power is selected by the drop surface thinning speed.

Timing to introduce moisture, moisture flux and duration, substrate heating and environmental temperature and humidity. The timing of introducing moisture is selected before, at, and after the end of “methanol-rich” evaporation regime to determine the effects of residual methanol. It is designed based on the in situ microscopy study about the timing of cell flattening. Moisture flux and duration design can also benefit from the in situ study. The flux is designed around the point that induces optimum cell swelling. The duration is generally several seconds, but can be readily varied. The substrate is ITO coated glass that is heated up to 80° C. Temperature and humidity are varied to test process sensitivity to the environment.

Common parameters: drop volume and drop height. There is an incentive to minimize drop volume to reduce the footprint on the glass slide for high throughput application. However, this may change the local environment of the spreading cells because while the drop volume is scaled down, the size of the cells remains the same. Drop height is tested. We expect it should only affect the initial kinetic phase of drop impact [29] without splashing [30], although the mixture ratio may change due to drop evaporation in the air.

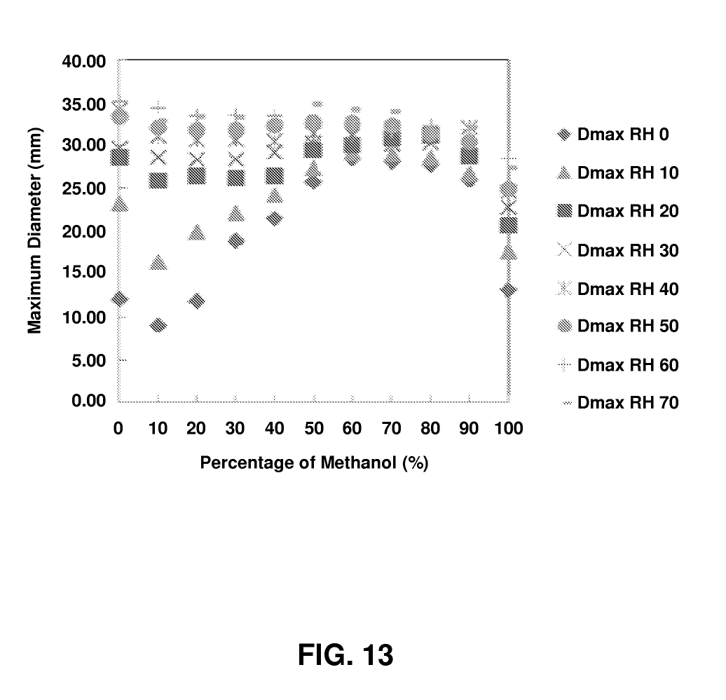

Variation from fixative mixture ratio, water contamination level: A key issue of existing metaphase spread process is its variable results. From a fixative dynamics point of view, the fixative reagent is a main source of variation. First of all, the fixative mixture ratio may deviate from the targeted 3:1 during mixing. Because methanol has a much higher vapor pressure than acetic acid, the ratio could also change after long time storage. We conduct a set of experiments to study the effects of mixing ratio. FIG. 13 shows initial results of how the drop maximum diameter changes with percentage of methanol under different RH. Secondly, because methanol is miscible with water and acetic acid is hygroscopic, water can be absorbed into the reagents easily during storage and handling. Claussen et al. [16] reported that water-induced swelling is a complicated reversible process that depends on the rate of water introduction (limited experiments were presented). We expect existing water in the fixative would change the behavior of the induced swelling. To study this effect, water is intentionally added into the fixative with varying percentage to simulate the water contamination in real samples. The effects are characterized by the interference fringe analysis.

Reagent control measures: These experiments require pure methanol and acetic acid, as well as accurate metering of methanol and acetic acid volumes during mixing. Anhydrous methanol and glacier acetic acid with the highest purity are obtained from a commercial company. The reagents are stored inside a sealed glass jar with desiccant (such as CaO or Drierite) and the jar stored inside a dry air purged box.

Molecular sieves #3 may be used inside the methanol bottle to remove any absorbed moisture. To reduce the mixing variation, a positive-displacement pipette that is designed to pipette volatile liquid such as methanol and acetic acid is used. Mixing of the fixative is carried out inside the environmental box with dry air.

Storage condition test: It is reported that harvested cells can be stored long-term in Eppendorf tubes at −20° C. or −80° C. (months or years). The methanol/acetic acid ratio and water contaminant level may change with storage time. The collected data on the effects of mixture ratio and water contamination level is used as a reference. The stored fixative with different duration is dropped and the dynamics compared with the reference data. Certain markers such as “acetic acid-rich” layer thickness can indicate acetic acid percentage, and the formation of “finger-instability” at the edge of the drop (see, e.g., FIG. 9) as well as “water-rich” regime lifetime can indicate water contaminant and its level. The absorption of water is also estimated from analytical theories.

Qualitative understanding and interpretation of fluid dynamics data: Multi-component complete wetting sessile drop spreading and evaporation, such as in the Carnoy's fixative case, is a complicated process that does not yet have theoretical model and analytical solution. The drop spreading is driven by concentration-induced Marangoni flow. The evaporation can be controlled by vapor diffusion in air for slow evaporation, or the heating flux for heated substrate with fast evaporation. The challenge of reaching a complete theoretical model lies in the fact that the component ratio in the drop is not uniform, but a function of location and time. The interference technique described herein can experimentally measure the dynamics of drop profile, which can help build theoretical models for the system. Here we focus on qualitative understanding of the cell local fluid environment, including the film thickness and major component of the fluid (from evaporation regime). Single-component fluid evaporation theories are used when appropriate to estimate the effects of different parameters if a uniform component ratio can be assumed and evaporations of different components can be assumed to be proportional to their ratio. Single-component liquid sessile drop evaporation theories are reviewed in Cazabat et al. [31] and Erbil [32]. Finite element method simulation of multi-phase system with moving boundaries such as evaporation is also challenging. But for cases where quasi equilibrium can be reached, such as slow evaporation, as well as pure liquid can be used as upper/lower bound estimate of the conditions, COMSOL Multiphysics can be used to give more insight into the system, such as estimating the cooling effect of the sessile drop due to evaporation.

Characterization of chromosome metaphase spread: The quality of metaphase spreads is characterized by their metaphase area, lengths of chromosome, number of broken cells, and number of chromosome overlaps [17-19,22,23] to guide the process design. Metaphase area is an indicator of the degree of cell swelling, and larger cells should have less chromosome overlap. Longer length of chromosome may give better resolution for dicentric identification (good for FISH assays too). Broken cells with scattered chromosomes are excluded from the analysis. Its number is used as an indicator of process quality.

Design and testing of optimized predictive and robust metaphase spreading process: The data generated for these scenarios provide a better understanding of the chromosome metaphase spreading process. The source of the process variation from the fixative dynamics can be identified. For example, it can be seen from FIG. 13 that pure acetic acid can spread well at 30% or more RH. Because Claussen et al. reported that preferential evaporation of methanol was necessary for cell swelling [16], it could be beneficial to use pure acetic acid at high RH for metaphase spread to avoid methanol. Moreover, testing the hypothesis of water-induced cell swelling by in situ microscopy can provide decisive timing for introducing moisture based on the interference fringe analysis of evaporation regime. From this information, an optimized metaphase spreading process is generated that is both predictive and robust.

Demonstration of the optimized metaphase spread process for dicentric identification: The newly optimized process has advantages for dicentric identification. Blood sample is irradiated ex vivo to induce dicentrics in the lymphocytes. Quality of metaphase spreads from the irradiated samples are examined according to the parameters listed before. The dicentrics are scored. Only complete metaphase with 46 chromosomes are used for dicentric scoring [25]. To score a dicentric, it is also important to have balanced chromosomes, i.e. if a spread contains a dicentric, it should also contains an acentric fragment with total chromosome number of 46. The number of dicentrics scored, as well as rejected due to chromosome overlapping, twisting, touching etc [8] are used as the indicators for dicentric identification. The number of chromosomes that no conclusion can be made are documented as an indicator. The scoring of dicentrics can be compared between the newly developed process and traditional processes.

Ex vivo blood irradiation can be used to test a gene expression based biodosimetry assay [33]. In this example, blood sample is irradiated in a similar manner as [33]. Briefly, a Varian 21EX linear accelerator (LINAC) is used. A customized tube holder phantom that mimics a body material heterogeneity, and a radiation beam for the most homogeneous dose distribution to the sample is used. 3% dose variation is achieved. Sample can be irradiated at different doses, e.g. 0, 0.5, 1, 2, 3, 4 Gy, then transported for downstream processing. A preliminary dose-response curve is plotted from these samples using DCA. A linear quadratic response is expected. FPG should be used to exclude M2 cells from dicentric scoring.

The methods and systems provided herein result in the design knowledge and a predictive process for high quality metaphase spread and improved dicentric identification. This may be combined with other automated dicentric assay infrastructures in a high throughput fashion. For example, the methods and systems may be used with a small footprint 96-well plate spreading process to provide high-throughput . The samples may be evaluated by an automated scoring system, and validated for DCA dosimetry. Other applications of the process in e.g. cancer research and clinical diagnostics are also compatible with the instant methods and systems.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

When a group of substituents is disclosed herein, it is understood that all individual members of that group and all subgroups, are disclosed separately. When a Markush group or other grouping is used herein, all individual members of the group and all combinations and subcombinations possible of the group are intended to be individually included in the disclosure. Every formulation or combination of components described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art.

For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

### EXAMPLE 1

### REFERENCES

[1] T. Liehr, A. Weise, A. B. Hamid, X. B. Fan, E. Klein, N. Aust, M. A. K. Othman, K. Mrasek, N. Kosyakova, Multicolor FISH methods in current clinical diagnostics, Expert Rev. Mol. Diagn. 13 (2013) 251-255.

[2] D. A. Ribeiro, Cytogenetic biomonitoring in oral mucosa cells following dental X-ray, Dentomaxillofac. Radiol. 41 (2012) 181-184.

[3] W. G. Li, J. Vijg, Measuring Genome Instability in Aging—A Mini-Review, Gerontology 58 (2012) 129-138.

[4] M. Fenech, Current status, new frontiers and challenges in radiation biodosimetry using cytogenetic, transcriptomic and proteomic technologies, Radiat. Meas. 46 (2011) 737-741.

[5] J. A. Bridge, A. M. Cushman-Vokoun, Molecular Diagnostics of Soft Tissue Tumors, Arch. Pathol. Lab. Med. 135 (2010) 588-601.

[6] J. L. Spurbeck, A. R. Zinsmeister, K. J. Meyer, S. M. Jalal, Dynamics of chromosome spreading, Am. J. Med. Genet. 61(1996) 387-393.

[7] O. Henegariu, N. A. Heerema, L. L. Wright, P. Bray-Ward, D. C. Ward, G. H. Vance, Improvements in cytogenetic slide preparation: Controlled chromosome spreading, chemical aging and gradual denaturing, Cytometry 43 (2001) 101-109.

[8] W. Deng, S. W. Tsao, J. N. Lucas, C. S. Leung, A. L. M. Cheung, A new method for improving metaphase chromosome spreading, Cytom. Part A 51A (2003) 46-51.

[9] F. T. Bosman, M. Vanderploeg, A. Schaberg, P. Vanduijn, CHROMOSOME PREPARATIONS OF HUMAN-BLOOD LYMPHOCYTES—EVALUATION OF TECHNIQUES, Genetica 45 (1975) 425-433.

[10] K. Yamada, K. Kakinuma, H. Tateya, C. Miyasaka, DEVELOPMENT OF AN INSTRUMENT FOR CHROMOSOME SLIDE PREPARATION, J. Radiat. Res. 33 (1992) 242-249.

[11] Y. Y. Qu, L. Y. Xing, E. D. Hughes, T. L. Saunders, Chromosome Dropper Tool: Effect of slide angles on chromosome spread quality for murine embryonic stem cells, J. Histotechnol. 31(2008) 75-79.

[12] U. Claussen, S. Michel, P. Muhlig, M. Westermann, U. W. Grummt, K. Kromeyer-Hauschild, T. Liehr, Demystifying chromosome preparation and the implications for the concept of chromosome condensation during mitosis, Cytogenet. Genome Res. 98 (2002) 136-146.

[13] R. Hliscs, P. Muhlig, U. Claussen, The spreading of metaphases is a slow process which leads to a stretching of chromosomes, Cytogenet. Cell Genet. 76 (1997) 167-171.

[14] P. L. Kelly-Zion, C. J. PurseII, S. Vaidya, J. Batra, Evaporation of sessile drops under combined diffusion and natural convection, Colloid Surf. A-Physicochem. Eng. Asp. 381 (2011) 31-36.

[15] R. Rioboo, M. Marengo, C. Tropea, Time evolution of liquid drop impact onto solid, dry surfaces, Exp. Fluids 33 (2002) 112-124.

[16] A. L. Biance, C. Clanet, D. Quere, First steps in the spreading of a liquid droplet, Phys. Rev. E 69 (2004) 4.

[17] T. A. H. Nguyen, A. V. Nguyen, M. A. Hampton, Z. P. Xu, L. B. Huang, V. Rudolph, Theoretical and experimental analysis of droplet evaporation on solid surfaces, Chem. Eng. Sci. 69 (2012) 522-529.

[18] J.D. Chen, EXPERIMENTS ON A SPREADING DROP AND ITS CONTACT-ANGLE ON A SOLID, J. Colloid Interface Sci. 122 (1988) 60-72.

[19] K. S. Lee, C. Y. Cheah, R. J. Copleston, V. M. Starov, K. Sefiane, Spreading and evaporation of sessile droplets: Universal behaviour in the case of complete wetting, Colloid Surf. A-Physicochem. Eng. Asp. 323 (2008) 63-72.

[20] C. Poulard, G. Guena, A. M. Cazabat, A. Boudaoud, M. Ben Amar, Rescaling the dynamics of evaporating drops, Langmuir 21(2005) 8226-8233.

[21] C. Poulard, O. Benichou, A. M. Cazabat, Freely receding evaporating droplets, Langmuir 19 (2003) 8828-8834.

[22] G. Guena, C. Poulard, A. M. Cazabat, Evaporating drops of alkane mixtures, Colloid Surf. A-Physicochem. Eng. Asp. 298 (2007) 2-11.

[23] G. Guena, C. Poulard, A. M. Cazabat, The leading edge of evaporating droplets, J. Colloid Interface Sci. 312 (2007) 164-171.

[24] P.G. Degennes, WETTING—STATICS AND DYNAMICS, Rev. Mod. Phys. 57 (1985) 827-863.

[25] A. M. Cazabat, G. Guena, Evaporation of macroscopic sessile droplets, Soft Matter 6 (2010) 2591-2612.

[26] R. D. Deegan, O. Bakajin, T. F. Dupont, G. Huber, S. R. Nagel, T. A. Witten, Capillary flow as the cause of ring stains from dried liquid drops, Nature 389 (1997) 827-829.

[27] H. Hu, R. G. Larson, Analysis of the microfluid flow in an evaporating sessile droplet, Langmuir 21(2005) 3963-3971.

[28] H. Hu, R. G. Larson, Analysis of the effects of Marangoni stresses on the microflow in an evaporating sessile droplet, Langmuir 21(2005) 3972-3980.

[29] Y. O. Popov, Evaporative deposition patterns: Spatial dimensions of the deposit, Phys. Rev. E 71 (2005) 17.

[30] R. Bhardwaj, X. H. Fang, D. Attinger, Pattern formation during the evaporation of a colloidal nanoliter drop: a numerical and experimental study, New J. Phys. 11 (2009) 33.

[31] R. Bhardwaj, X. H. Fang, P. Somasundaran, D. Attinger, Self-Assembly of Colloidal Particles from Evaporating Droplets: Role of DLVO Interactions and Proposition of a Phase Diagram, Langmuir 26 (2010) 7833-7842.

[32] D. Pesach, A. Marmur, MARANGONI EFFECTS IN THE SPREADING OF LIQUID-MIXTURES ON A SOLID, Langmuir 3 (1987) 519-524.

[33] S. Singh, B. S. Lark, S. K. Aggarwal, SURFACE TENSIONS OF MIXTURES OF METHANOL WITH ACETIC-ACID, ACETONE, CHLOROFORM, TOLUENE AND CARBON-TETRACHLORIDE, Indian J. Chem. Sect A-Inorg. Phys. Theor. Anal. Chem. 21 (1982) 1116-1119.

[34] H. M. Padilla-Nash, L. Barenboim-Stapleton, M. J. Difilippantonio, T. Ried, Spectral karyotyping analysis of human and mouse chromosomes, Nat. Protoc. 1 (2006) 3129-3142.

[35] C. K. Law, T. Y. Xiong, C. H. Wang, ALCOHOL DROPLET VAPORIZATION IN HUMID AIR, Int. J. Heat Mass Transf. 30 (1987) 1435-1443.

### EXAMPLE 2

### REFERENCES

[1] W. F. Blakely, C. A. Salter, P. G. S. Prasanna, Early-response biological dosimetry—Recommended countermeasure enhancements for mass-casualty radiological incidents and terrorism, Health Phys. 89 (2005) 494-504.

[2] A. B. Flood, R. J. NicolaIde, E. Demidenko, B. B. Williams, A. Shapiro, A. L. Wiley, H. M. Swartz, A framework for comparative evaluation of dosimetric methods to triage a large population following a radiological event, Radiat. Meas. 46 (2011) 916-922.

[3] E. A. Ainsbury, E. Bakhanova, J. F. Barquinero, M. Brai, V. Chumak, V. Correcher, F. Darroudi, P. Fattibene, G. Gruel, I. Guclu, S. Horn, A. Jaworska, U. Kulka, C. Lindholm, D. Lloyd, A. Longo, M. Marrale, O. M. Gil, U. Oestreicher, J. Pajic, B. Rakic, H. Romm, F. Trompier, I. Veronese, P. Voisin, A. Vral, C. A. Whitehouse, A. Wieser, C. Woda, A. Wojcik, K. Rothkamm, REVIEW OF RETROSPECTIVE DOSIMETRY TECHNIQUES FOR EXTERNAL IONISING RADIATION EXPOSURES, Radiat. Prot. Dosim. 147 (2011) 573-592.

[4] M. Pinto, N. F. G. Santos, A. Amaral, Current status of biodosimetry based on standard cytogenetic methods, Radiat. Environ. Biophys. 49 (2010) 567-581.

[5] H. Romm, U. Oestreicher, U. Kulka, Cytogenetic damage analysed by the dicentric assay, Ann. 1st. Super. Sanita 45 (2009) 251-259.

[6] P. R. Martin, R. E. Berdychevski, U. Subramanian, W. F. Blakely, P. G. S. Prasanna, Sample tracking in an automated cytogenetic biodosimetry laboratory for radiation mass casualties, Radiat. Meas. 42 (2007) 1119-1124.

[7] G. Garty, Y. H. Chen, H. C. Turner, J. Zhang, O. V. Lyulko, A. Bertucci, Y. P. Xu, H. L. Wang, N. Simaan, G. Randers-Pehrson, Y. L. Yao, D. J. Brenner, The RABiT: A Rapid Automated Biodosimetry Tool for radiological triage. II. Technological developments, Int. J. Radiat. Biol. 87 (2011) 776-790.

[8] H. Romm, E. Ainsbury, S. Barnard, L. Barrios, J. F. Barquinero, C. Beinke, M. Deperas, E. Gregoire, A. Koivistoinen, C. Lindholm, J. Moquet, U. Oestreicher, R. Puig, K. Rothkamm, S. Sommer, H. Thierens, V. Vandersickel, A. Vral, A. Wojcik, Automatic scoring of dicentric chromosomes as a tool in large scale radiation accidents, Mutat. Res. Genet. Toxicol. Environ. Mutagen. 756 (2013) 174-183.

[9] F. N. Flegal, Y. Devantier, L. Marro, R. C. Wilkins, VALIDATION OF QUICKSCAN DICENTRIC CHROMOSOME ANALYSIS FOR HIGH THROUGHPUT RADIATION BIOLOGICAL DOSIMETRY, Health Phys. 102 (2012) 143-153.

[10] C. Schunck, T. Johannes, D. Varga, T. Larch, A. Plesch, New developments in automated cytogenetic imaging: unattended scoring of dicentric chromosomes, micronuclei, single cell gel electrophoresis, and fluorescence signals, Cytogenet. Genome Res. 104 (2004) 383-389.

[11] A. Vaurijoux, G. Gruel, F. Pouzoulet, E. Gregoire, C. Martin, S. Roch-Lefevre, P. Voisin, L. Roy, Strategy for Population Triage Based on Dicentric Analysis, Radiat. Res. 171 (2009) 541-548.

[12] IAEA, Cytogenetic Analysis for Radiation Dose Assessment—A Manual, International Atomic Energy Agency, Vienna, 2001.

[13] R. C. Wilkins, H. Romm, U. Oestreicher, L. Marro, M. A. Yoshida, Y. Suto, P. G. S. Prasanna, Biological dosimetry by the triage dicentric chromosome assay—Further validation of international networking, Radiat. Meas. 46 (2011) 923-928.

[14] R. C. Wilkins, H. Romm, T. C. Kao, A. A. Awa, M. A. Yoshida, G. K. Livingston, M. S. Jenkins, U. Oestreicher, T.C. Pellmar, P.G.S. Prasanna, Interlaboratory comparison of the dicentric chromosome assay for radiation biodosimetry in mass casualty events, Radiat. Res. 169 (2008) 551-560.

[15] G. Livingston, Personal communicatoin, Oak Ridge, Tenn.

[16] U. Claussen, S. Michel, P. Muhlig, M. Westermann, U. W. Grummt, K. Kromeyer-Hauschild, T. Liehr, Demystifying chromosome preparation and the implications for the concept of chromosome condensation during mitosis, Cytogenet. Genome Res. 98 (2002) 136-146.

[17] J. L. Spurbeck, A. R. Zinsmeister, K. J. Meyer, S. M. Jalal, Dynamics of chromosome spreading, Am. J. Med. Genet. 61(1996) 387-393.

[18] O. Henegariu, N. A. Heerema, L. L. Wright, P. Bray-Ward, D. C. Ward, G. H. Vance, Improvements in cytogenetic slide preparation: Controlled chromosome spreading, chemical aging and gradual denaturing, Cytometry 43 (2001) 101-109.

[19] W. Deng, S. W. Tsao, J. N. Lucas, C. S. Leung, A. L. M. Cheung, A new method for improving metaphase chromosome spreading, Cytom. Part A 51A (2003) 46-51.

[20] F. T. Bosman, M. Vanderploeg, A. Schaberg, P. Vanduijn, CHROMOSOME PREPARATIONS OF HUMAN-BLOOD LYMPHOCYTES—EVALUATION OF TECHNIQUES, Genetica 45 (1975) 425-433.

[21] K. Yamada, K. Kakinuma, H. Tateya, C. Miyasaka, DEVELOPMENT OF AN INSTRUMENT FOR CHROMOSOME SLIDE PREPARATION, J. Radiat. Res. 33 (1992) 242-249.

[22] Y. Y. Qu, L. Y. Xing, E. D. Hughes, T. L. Saunders, Chromosome Dropper Tool: Effect of slide angles on chromosome spread quality for murine embryonic stem cells, J. Histotechnol. 31(2008) 75-79.

[23] R. Hliscs, P. Muhlig, U. Claussen, The spreading of metaphases is a slow process which leads to a stretching of chromosomes, Cytogenet. Cell Genet. 76 (1997) 167-171.

[24] H. M. Padilla-Nash, L. Barenboim-Stapleton, M. J. Difilippantonio, T. Ried, Spectral karyotyping analysis of human and mouse chromosomes, Nat. Protoc. 1 (2006) 3129-3142.

[25] IAEA, Cytogenetic Dosimetry: Applications in Preparedness for and Response to Radiation Emergencies, EPRBiodosimetry 2011 International Atomic Energy Agency, Vienna, 2011.

[26] ISO-21243, Radiation protection—Performance criteria for laboratories performing cytogenetic triage for assessment of mass casualties in radiological or nuclear emergencies—General principles and applications to dicentric assay, International Organization for Standardization, Geneva, Switzerland, 2008.

[27] WHO, Guidance on regulations for the Transport of Infectious Substances, 2013-2014.

[28] A. J. Hopwood, C. Hurth, J. N. Yang, Z. Cai, N. Moran, J. G. Lee-Edghill, A. Nordquist, R. Lenigk, M.D. Estes, J.P. Haley, C.R. McAlister, X. Chen, C. Brooks, S. Smith, K. Elliott, P. Koumi, F. Zenhausern, G. Tully, Integrated Microfluidic System for Rapid Forensic DNA Analysis: Sample Collection to DNA Profile, Anal. Chem. 82 (2010) 6991-6999.

[29] R. Rioboo, M. Marengo, C. Tropea, Time evolution of liquid drop impact onto solid, dry surfaces, Exp. Fluids 33 (2002) 112-124.

[30] R. L. Vander Wal, G. M. Berger, S. D. Mozes, The splash/non-splash boundary upon a dry surface and thin fluid film, Exp. Fluids 40 (2006) 53-59.

[31] A. M. Cazabat, G. Guena, Evaporation of macroscopic sessile droplets, Soft Matter 6 (2010) 2591-2612.

[32] N. Y. Erbil, Evaporation of pure liquid sessile and spherical suspended drops: A review, Adv. Colloid Interface Sci. 170 (2012) 67-86.

[33] M. Brengues, D. Liu, R. Korn, F. Zenhausern, Method for validating radiological samples using a linear accelerator, The European Physical Journal In press (2014).

1. A method of controlling droplet spreading on a surface, the method comprising the steps of:
suspending a biological component in a spreading solution to form a biological solution;
providing a droplet of said biological solution on a surface;
imaging interference fringes generated by said droplet on said surface, wherein the imaging is over a time course during which said droplet spreads on the surface;
determining a droplet parameter from said imaging step; and
controlling a process parameter to obtain an interference fringe pattern corresponding to a desired droplet parameter;
thereby controlling droplet spreading on a surface.

2. The method of claim 1, wherein said biological component is a whole cell.

3. The method of claim 1, wherein the droplet parameter is one or more of: drop film thickness; droplet cross-sectional profile; droplet diameter; surface thinning speed; and droplet composition.

4. The method of claim 1, wherein the process parameter is one or more of: humidity of the environment surrounding the droplet; droplet volume, droplet temperature; droplet evaporative dynamics, or time courses thereof.

5. The method of claim 4, wherein the one or more process parameters are varied over at least a portion of the time course to obtain a desired time course of interference fringes.

6. The method of claim 4, further comprising the step of adjusting humidity, temperature, or both humidity and temperature to provide water-induced swelling of said biological component.

7. The method of claim 6, wherein the adjusting is at a specific time interval during droplet spreading, and the adjusting controls a spreading solution composition time course, geometry time course, or both composition and geometry time course.

8. (canceled)

9. The method of claim 6, wherein the biological component comprises a cell and the adjusting step achieves optimum cell swelling for a metaphase analysis.

10. The method of claim 1, wherein the imaging comprises:
illuminating the droplet with a light source;
observing an image of the droplet with a camera; agel acquiring a time course video of droplet spreading with a computer from a plurality of observed images at different time points during droplet spreading wherein the interference fringes provide an optical resolution that is on a scale that is better than 1 μm; and
wherein the interference fringes generated by the drop spreading over time are recorded.

11-12. (canceled)

13. The method of claim 1, wherein the determining step comprises:
counting an order of interference fringes; and
fitting the counted order of interference fringes to a droplet profile or droplet thickness over time;
wherein the determining is at:
selected times over the time course during which the droplet spreads on the surface; or
a selected droplet location over the time course during which the droplet spreads on the surface.

14-15. (canceled)

16. The method of claim 13, wherein the determining step further comprises generating a droplet surface thinning speed versus time at a selected droplet location.

17. The method of claim 1, wherein the droplet comprises a plurality of biological cells positioned in an interior location of the droplet.

18. The method of claim 17, wherein the biological cells:
have been exposed to a source of radiation;
are from a biological sample containing potentially cancerous or pre-cancerous cells;
are from a pre-natal biological sample; or
are from a post-natal biological sample.

19. The method of claim 17 wherein at least a portion of the biological cells are in metaphase.

20. The method of claim 1, wherein the spreading solution fluid comprises a single fluid.

21. The method of claim 1, wherein the spreading solution comprises at least two distinct fluids.

22. The method of claim 1, wherein the spreading solution comprises one or more of: acetic acid; methanol; ethanol; mixtures thereof, such as a mixture of acetic acid and methanol.

23. The method of claim 22, wherein the fluid droplet is a mixture of a first fluid that is methanol and a second fluid that is acetic acid at a ratio of between 2.5:1 to 3.5:1.

24. (canceled)

25. The method of claim 20, wherein the first fluid and the second fluid have, relative to each other, a different evaporation rate and water absorption property, thereby facilitating swelling of a biological cell in the droplet; wherein the method further comprises the step of controlling an evaporative parameter of the fluid droplet by one or more of: varying a ratio of the first fluid to the second fluid; varying humidity level; or varying temperature; to obtain an optimized swelling of the biological swells for a metaphase analysis application.

26. (canceled)

27. The method of claim 1, wherein the droplet has an initial droplet volume when provided to the surface, the initial droplet volume that is greater than or equal to 1 μL and less than or equal to 1 mL.

28. The method of claim 1, wherein the droplet spreading is in a controllable and variable humidified environment.

29. The method of claim 1 used in an application selected from the group consisting of:
a cytogenetic assay;
a dicentric identification assay;
a radiological exposure assay;
a fluorescent in situ hybridization (FISH) assay;
a multi-color FISH (M-FISH) assay;
a spectral karyotyping assay; and
a chromosome banding assay (G-, C-, Q-, R-banding).

30. The method of claim 1, used in a high-throughput dicentric chromosome assay to provide a high-quality chromosome metaphase spread; wherein high-quality chromosome metaphase spread is characterized by one or more of: metaphase area, chromosome lengths, number of broken cells, number of chromosome overlaps.

31. (canceled)

32. The method of claim 1, further comprising:
controlling a temperature of the droplet; or
controlling relative humidity in an environment surrounding the droplet;
thereby affecting a fluid droplet composition corresponding to water content level or a percentage of a first fluid to a second fluid that forms the spreading solution;
wherein the controlling relative humidity is by providing a controllable external moisture flux source;
wherein the controlling the temperature of the droplet is by controlling a temperature:
on the surface on which the droplet spreads, wherein the surface and the droplet are in thermal communication; or
of an environment that surrounds the droplet.

33-34. (canceled)

35. The method of claim 1, wherein the controlling step comprises a feedback loop based on the interference fringes imaged during droplet spreading.

36. The method of claim 1, wherein the controlling step comprises an empirically-determined process parameter based on an initial droplet characteristic and desired end spreading outcome.

37. A method of controlling droplet spreading on a surface, the method comprising the steps of:
providing together a first fluid and a second fluid to form a spreading solution;
providing a droplet of said spreading solution on a surface;
imaging interference fringes generated by said droplet on said surface, wherein the imaging is over a time course during which said droplet spreads on the surface;
determining a droplet parameter from said imaging step; and
controlling a process parameter to obtain an interference fringe pattern corresponding to a desired droplet parameter;
thereby controlling droplet spreading on a surface.

38. A system for optically recording a droplet spreading over a support surface, the system comprising:
a support surface for supporting a droplet dynamically spreading over the support surface;
an optical imager for imaging of interference fringes as a droplet dynamically spreads over the support surface; and
an analyzer that analyses the interference fringes to calculate a droplet parameter that changes with time of droplet spreading.

39-42. (canceled)

43. The method of claim 1, further comprising the step of imaging the biological component by phase contrast microscopy.

44. The method of claim 1, wherein the spreading solution is a fixative solution.
